(19) United States
(12) Patent Application Publication
(10) Pub. No.: US 2018/0349024 A1
(43) Pub. Date: Dec. 6, 2018

(54) DISPLAY DEVICE, DISPLAY PROGRAM, AND DISPLAY METHOD

(71) Applicant: NIKON CORPORATION, Tokyo (JP)

(72) Inventors: Kaoru YOSHINO, Tokyo (JP); Yuki KATSUMATA, Kawasaki-shi (JP); Yoshiaki MIYAKAWA, Tokyo (JP); Takashi KURIYAMA, Yokohama-shi (JP)

(73) Assignee: NIKON CORPORATION, Tokyo (JP)

(21) Appl. No.: 15/780,140

(22) PCT Filed: Nov. 30, 2016
(86) PCT No.: PCT/JP2016/085619

§ 371 Date: May 30, 2018

(30) Foreign Application Priority Data
Nov. 30, 2015 (JP) 2015-234193
Nov. 30, 2015 (JP) 2015-234194

(51) Int. Cl. G06F 3/0488; G02F 1/1333; G06F 3/041

(52) U.S. Cl. CPC G06F 3/04886; G06F 3/0414; G02F 1/13338; G06F 3/04883

(57) ABSTRACT

A display device includes: a display; and a controller that executes control so as to employ a first or second display mode. The first display mode includes first areas and first images; the second display mode includes second areas and second images; at least one of the second areas has a size different from sizes of the first areas or the number of the second areas is different from the number of the first areas; content of at least one image among the second images is different from content of the first images; and upon detecting at least one of an instruction for image selection issued to select at least one image among the first images and an instruction for area selection issued to select at least one area among the first areas, the controller switches from the first to the second display mode.

### TECHNICAL FIELD

The present invention relates to a display device, a display program, and a display method.

### BACKGROUND ART

There are image display systems known in the related art that allow a plurality of images to be brought up on display in a single screen by partitioning the screen into a plurality of screen areas and laying out the plurality of images in the plurality of screen areas (see, for instance, PTL 1). However, there is an issue to be addressed in the related art in that a complicated operation needs to be performed in order to adjust the layout.

### CITATION LIST

### Patent Literature

PTL 1: Japanese Laid Open Patent Publication No. 2010-278824

### SUMMARY OF INVENTION

According to a first aspect, a display device comprises: a display at which a plurality of images is displayed; and a controller that executes control so as to employ a first display mode or a second display mode for a display mode in which the plurality of images is displayed at the display, wherein: the first display mode is a display mode which includes a plurality of first areas and a plurality of first images; the second display mode is a display mode which includes a plurality of second areas and a plurality of second images; at least one of the plurality of second areas has a size different from sizes of the plurality of first areas or the number of the plurality of second areas is different from the number of the plurality of first areas; content of at least one image among the plurality of second images is different from content of the plurality of the first images; and upon detecting at least one of an instruction for image selection issued to select at least one image among the plurality of first images and an instruction for area selection issued to select at least one area among the plurality of first areas, the controller switches from the first display mode to the second display mode.

According to a second aspect, a display device comprises: a display at which a plurality of images is displayed; and a controller that executes control so as to employ a first display mode or a second display mode for a display mode in which the plurality of images is displayed at the display; wherein: the first display mode is a display mode for displaying images in a plurality of first areas; the second display mode is a display mode for displaying images in a plurality of second areas; at least one of the plurality of second areas has a size different from sizes of the plurality of first areas or the number of the plurality of second areas is different from the number of the plurality of first areas; and upon detecting an instruction for selecting at least one area among the plurality of first areas or an image displayed in the area, the controller switches from the first display mode to the second display mode.

According to a third aspect, a display program enables a computer to execute: a display step in which a plurality of images is displayed at a display screen; and a control step in which control is executed so as to employ a first display mode or a second display mode for a display mode in which the plurality of images is displayed at the display screen, wherein: the first display mode is a display mode which includes a plurality of first areas and a plurality of first images; the second display mode is a display mode which includes a plurality of second areas and a plurality of second images; at least one of the plurality of second areas has a size different from sizes of the plurality of first areas or the number of the plurality of second areas is different from the number of the plurality of first areas; content of at least one image among the plurality of second images is different from content of the plurality of first images; and in the control step, once at least one of an instruction for image selection issued to select at least one image among the plurality of first images and an instruction for area selection issued to select at least one area among the plurality of first areas is detected, the display mode is switched from the first display mode to the second display mode.

According to a fourth aspect, a display method comprises: a display step in which a plurality of images is displayed at a display screen; and a control step in which control is executed so as to employ a first display mode or a second display mode for a display mode in which the plurality of images is displayed at the display screen, wherein: the first display mode is a display mode which includes a plurality of first areas and a plurality of first images; the second display mode is a display mode which includes a plurality of second areas and a plurality of second images; and in the control step, once at least one of an instruction for image selection issued to select at least one image among the plurality of first images and an instruction for area selection issued to select at least one area among the plurality of first areas is detected, the display mode is switched from the first display mode to the second display mode.

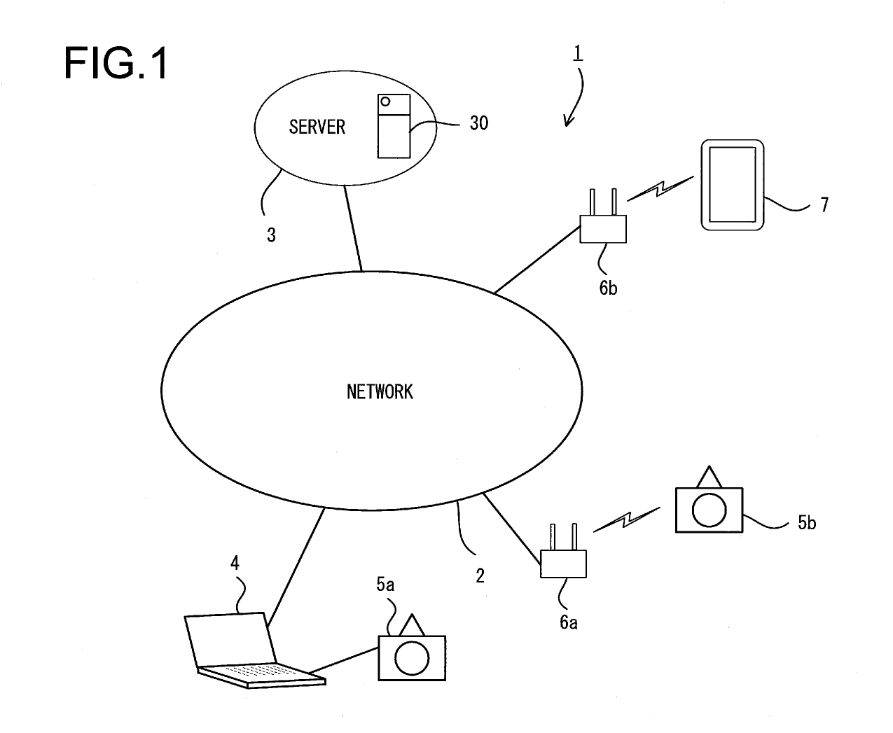

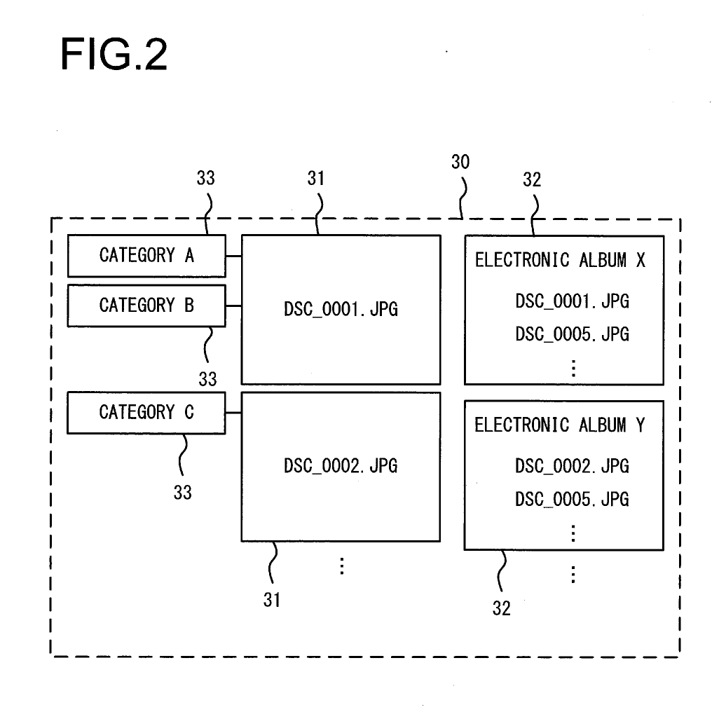

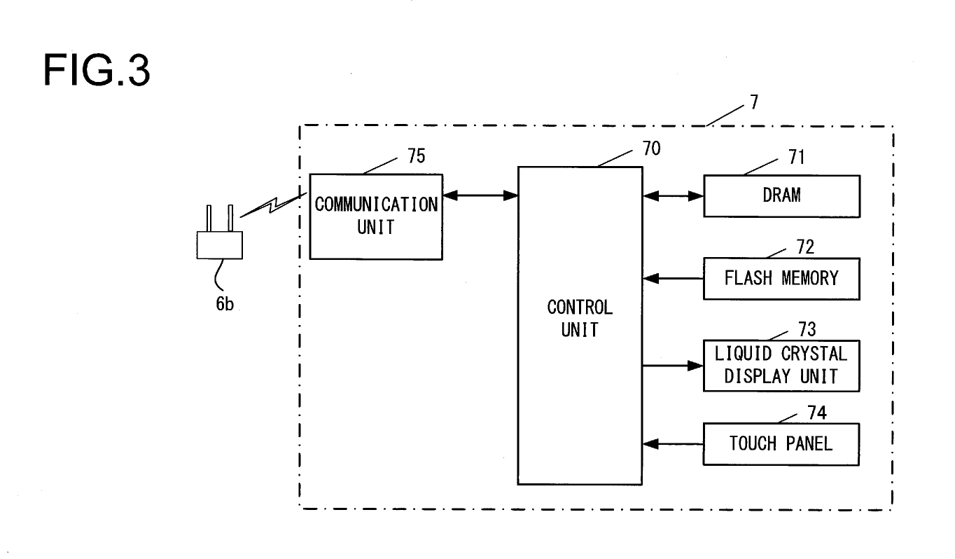

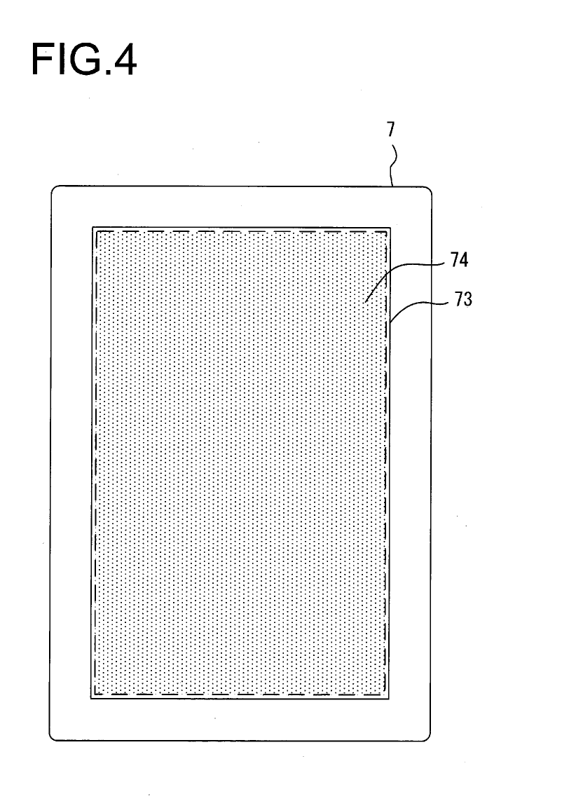

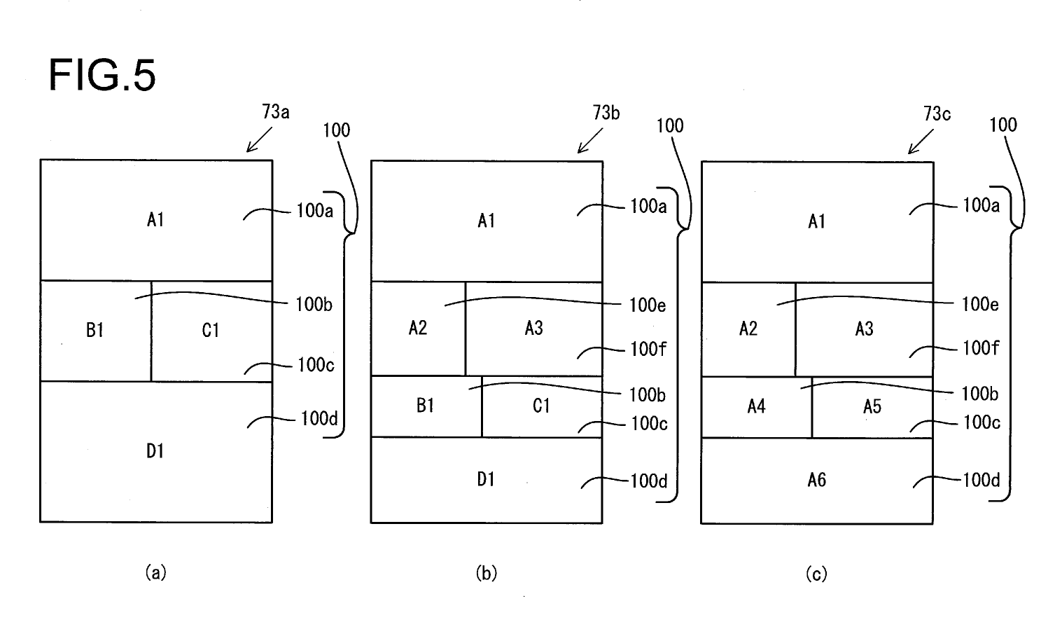

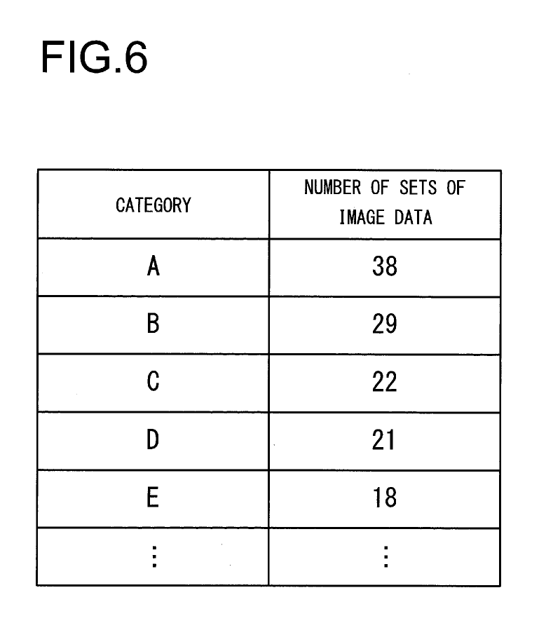

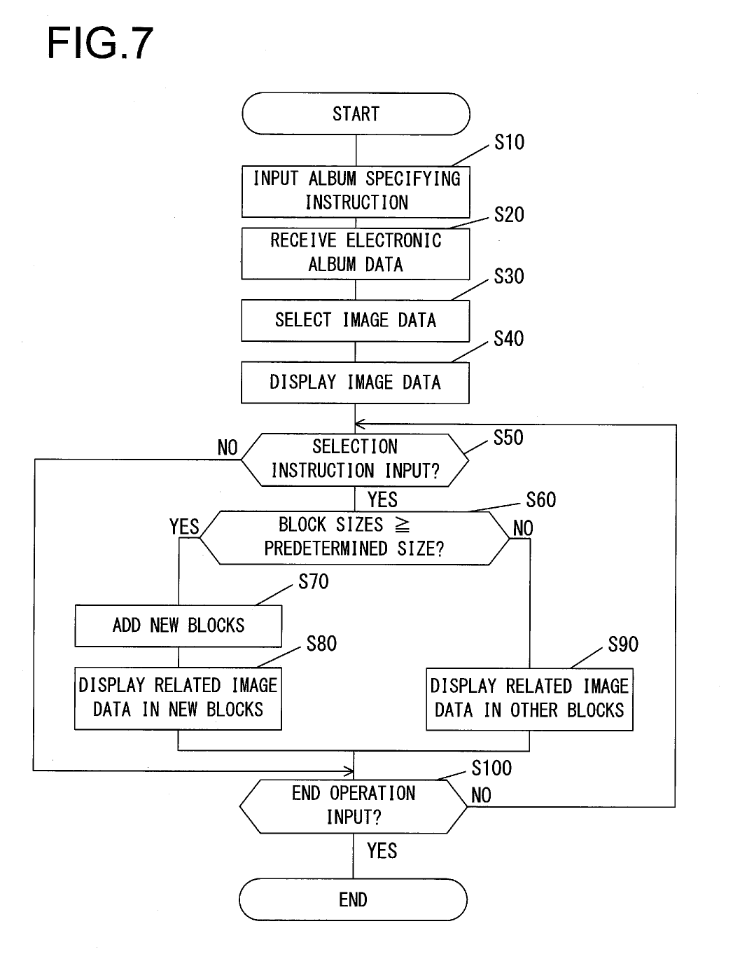

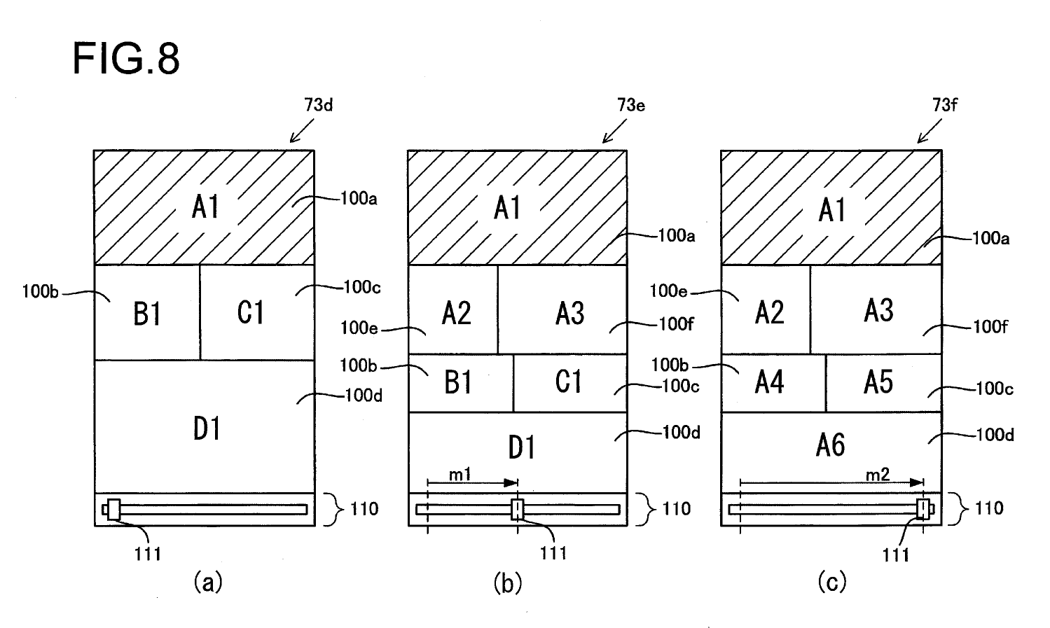

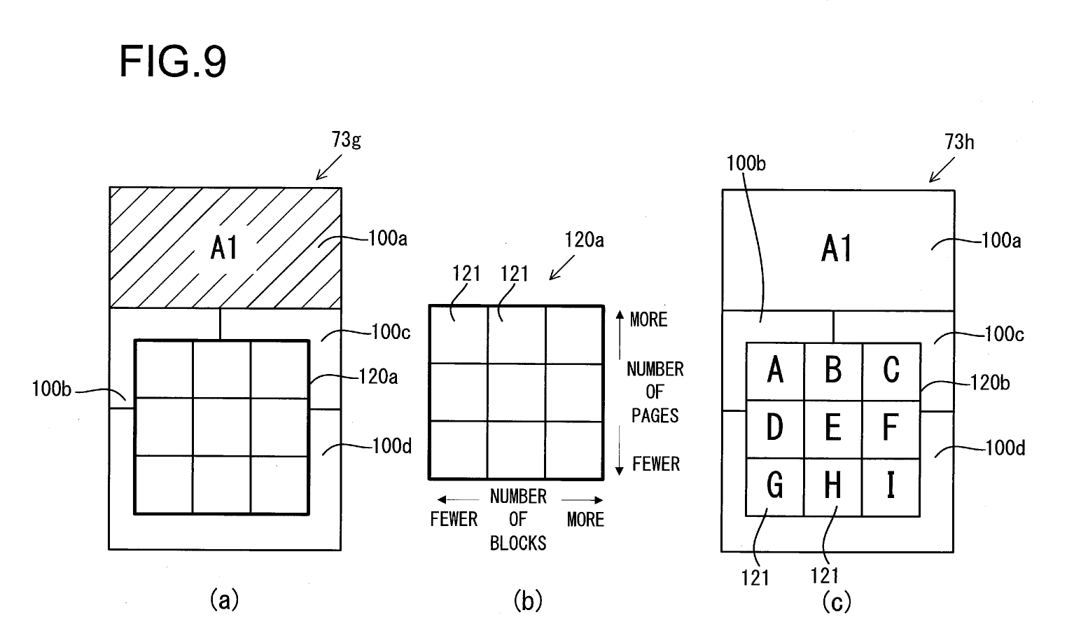

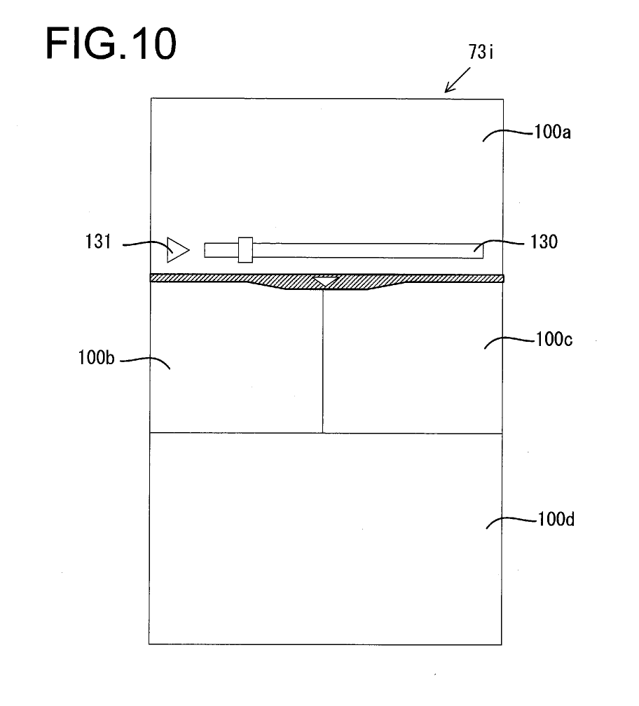

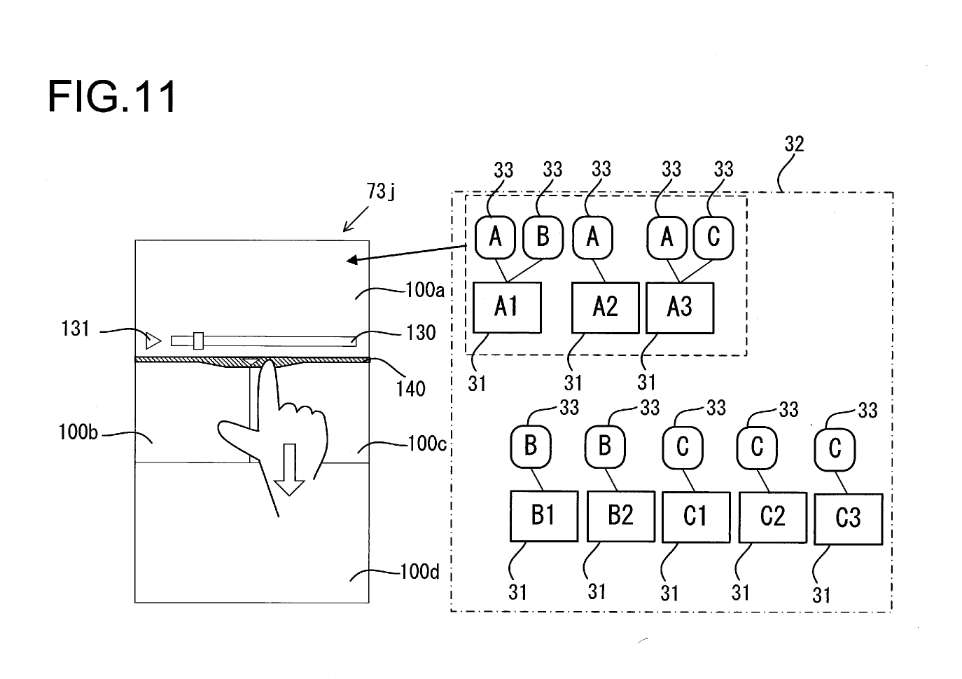

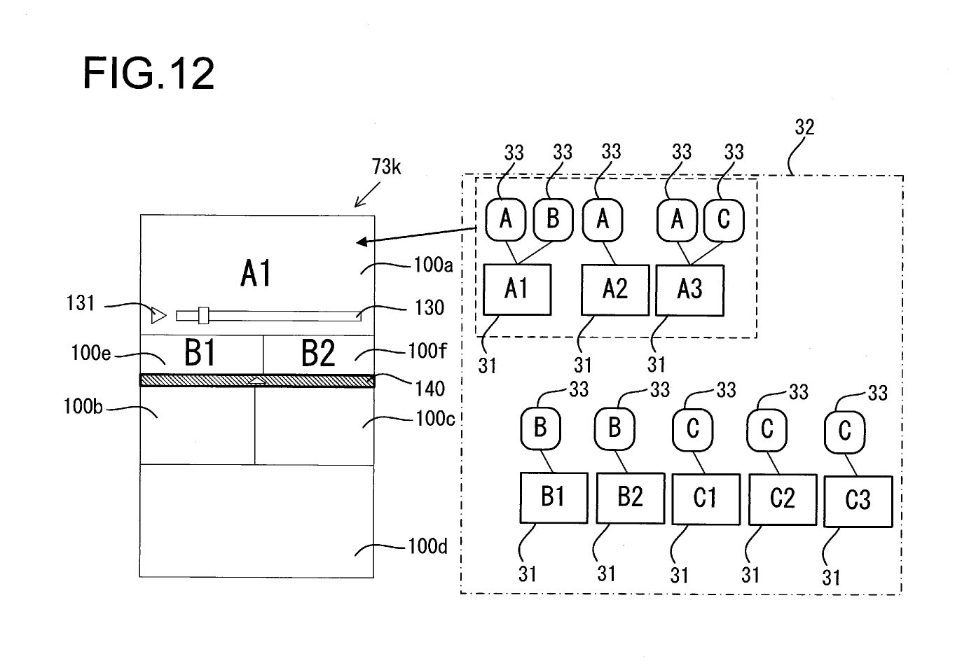

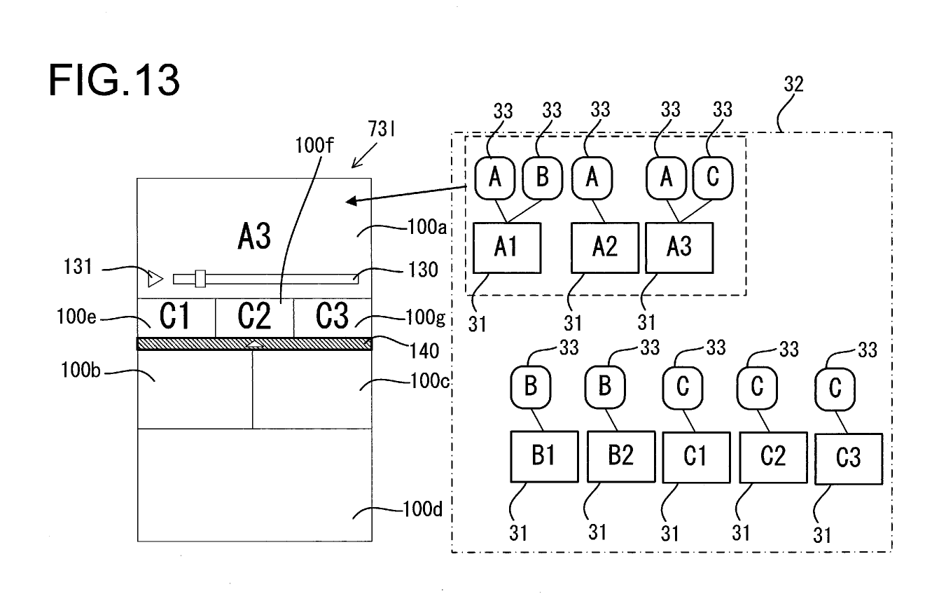

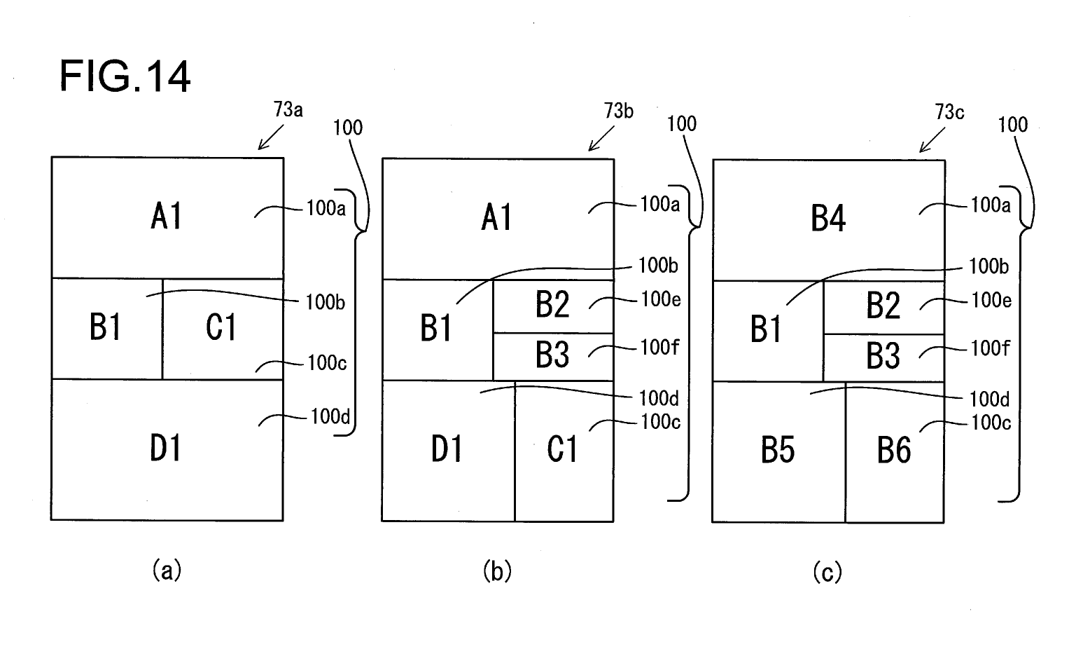

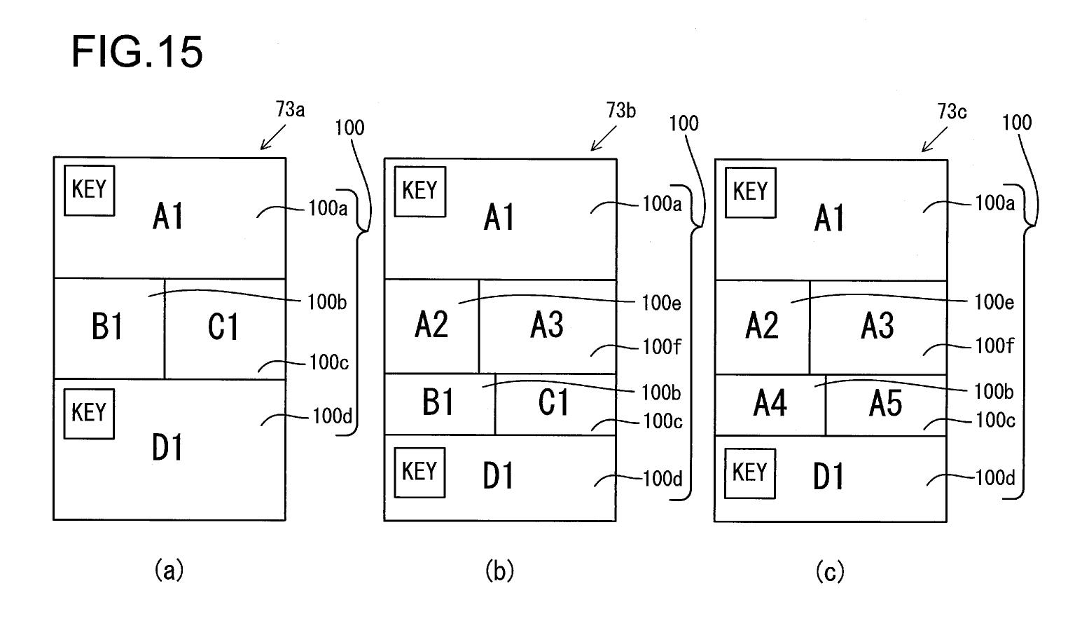

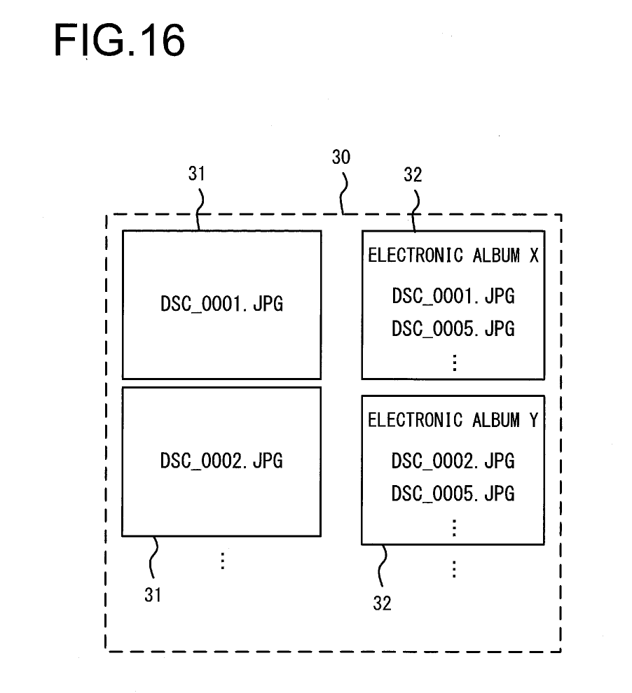

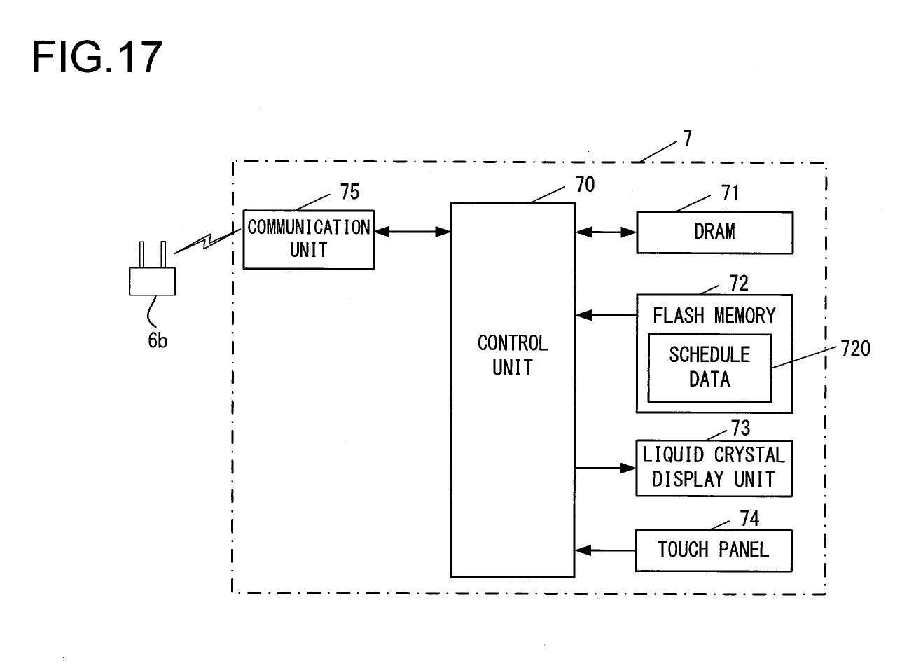

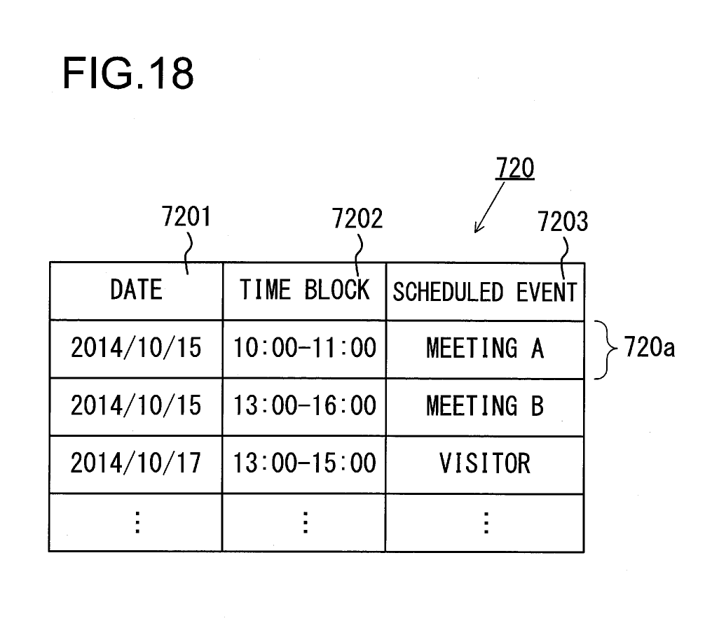

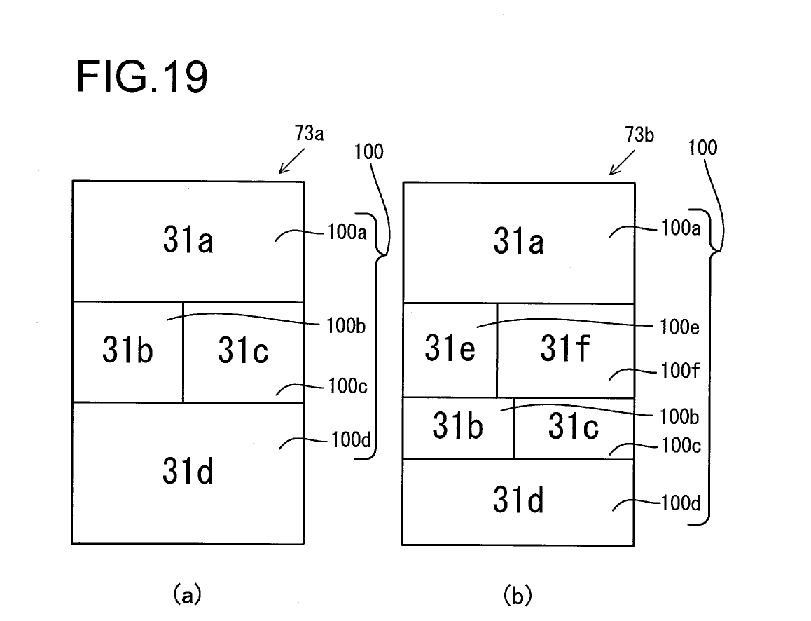

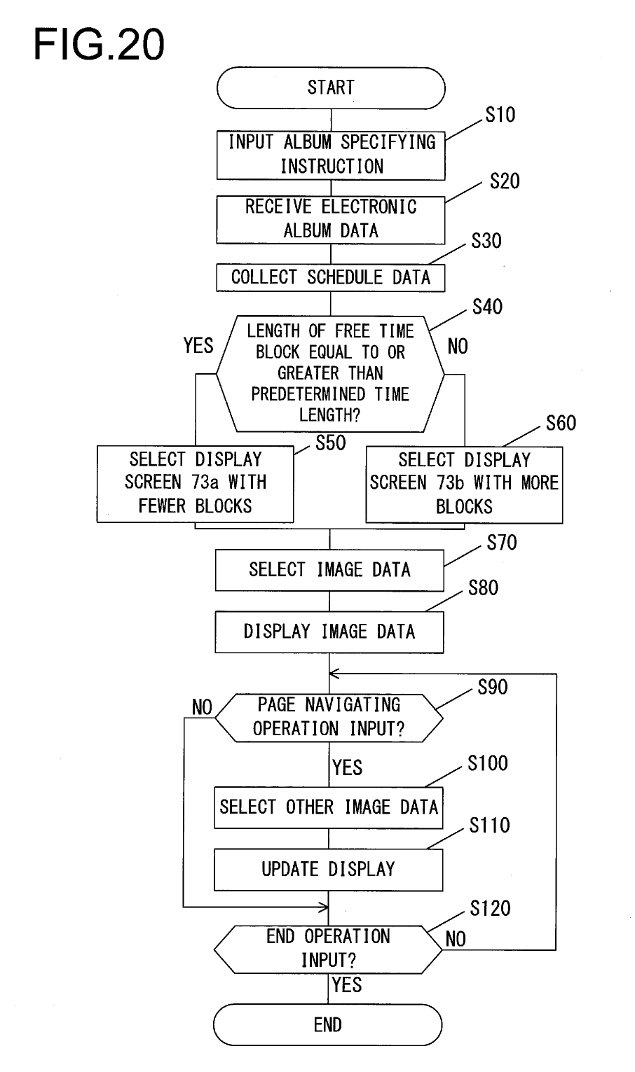

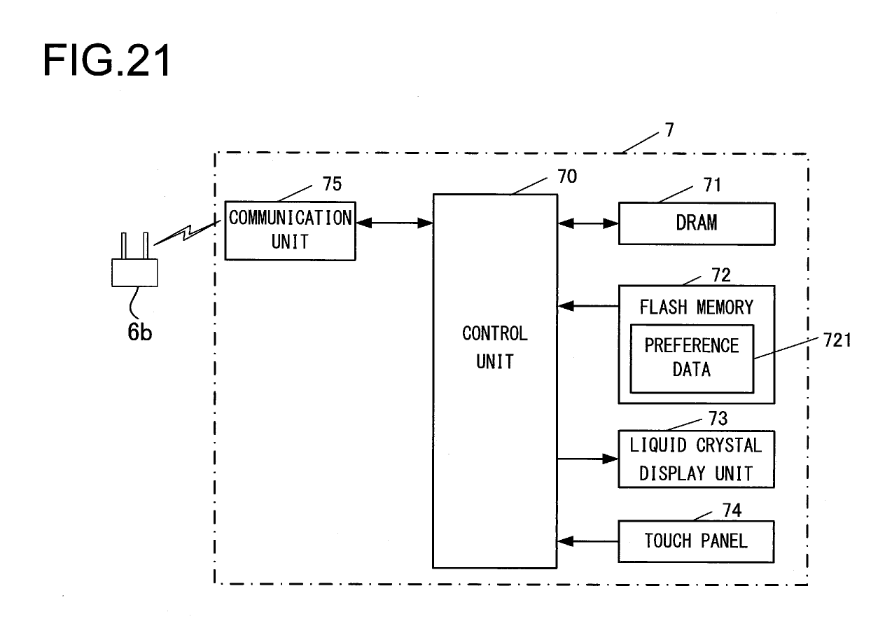

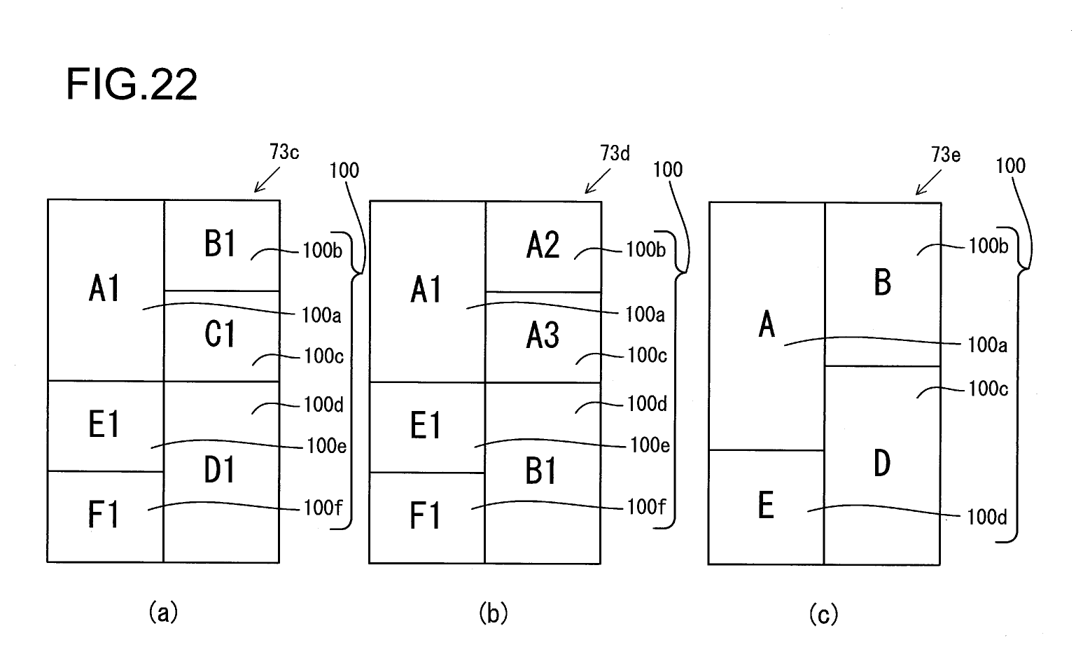

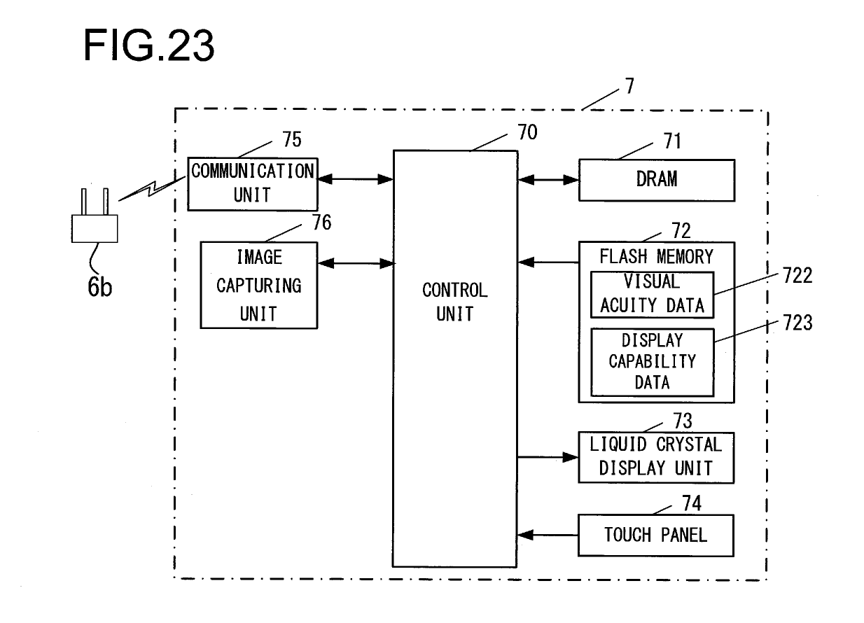

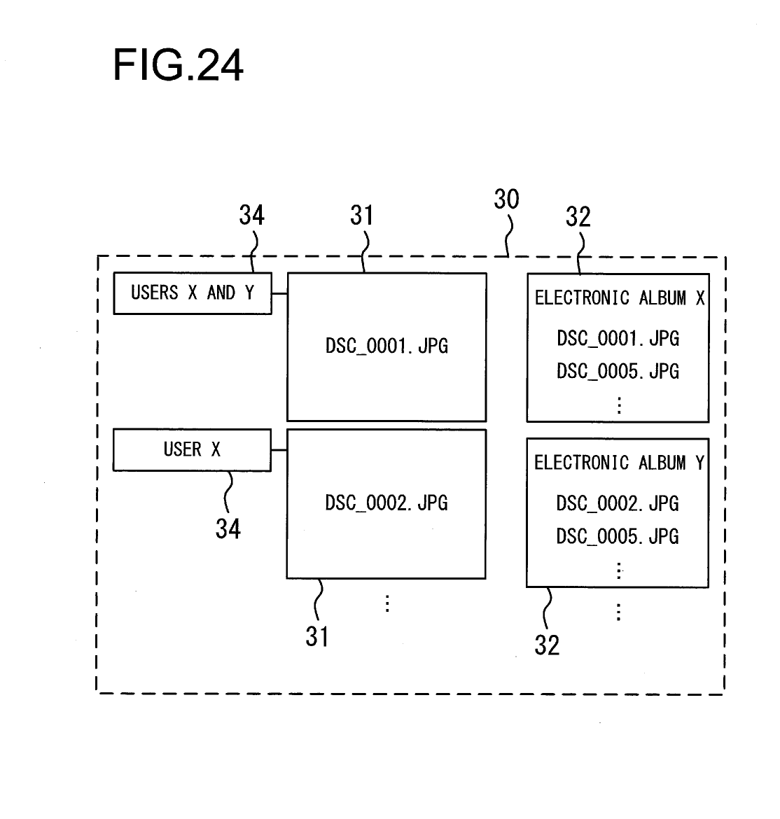

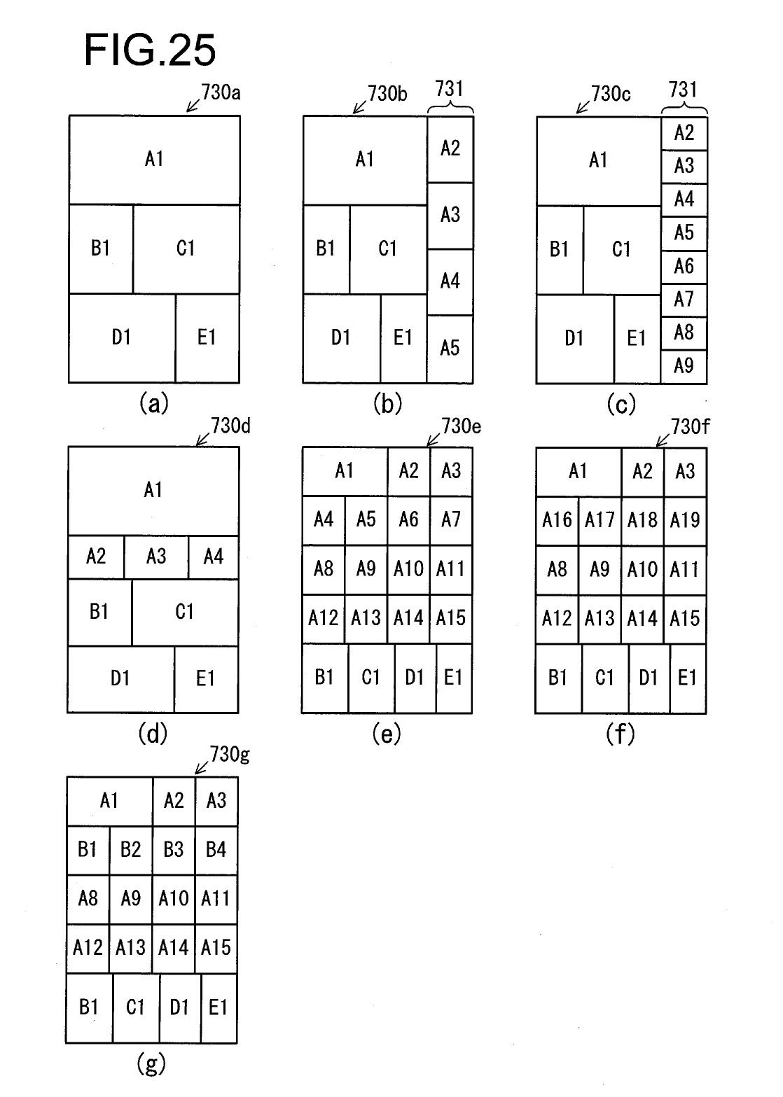

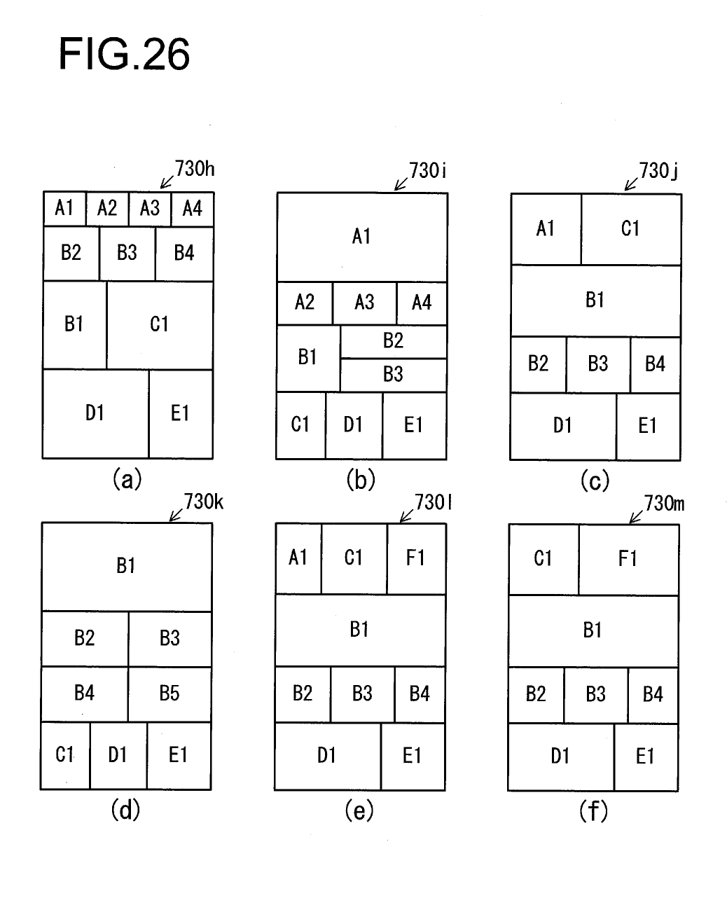

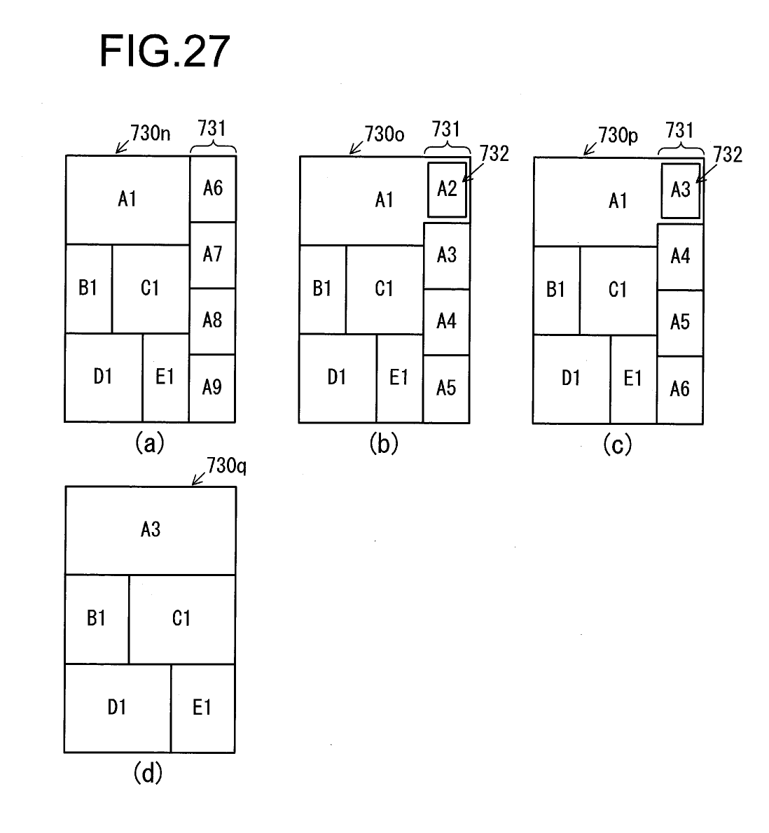

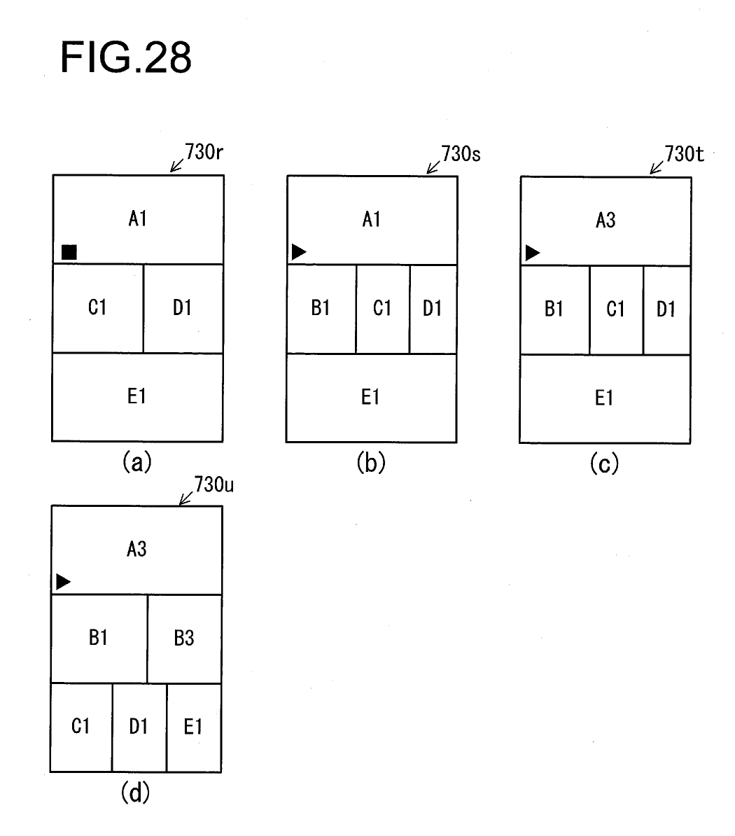

### BRIEF DESCRIPTION OF DRAWINGS

[FIG. 1] A block diagram illustrating the configuration of an image reproduction system achieved in a first embodiment

[FIG. 2] A schematic diagram illustrating data stored in a storage device 30

[FIG. 3] A schematic block diagram illustrating the structure of a portable device 7

[FIG. 4] A schematic diagram illustrating the external appearance of the portable device 7

[FIG. 5] Examples of display screens brought up while reproducing an electronic album in the first embodiment

[FIG. 6] A diagram illustrating how image data 31 may be selected

[FIG. 7] A flowchart of reproduction processing

[FIG. 8] Examples of display screens brought up while reproducing an electronic album in a second embodiment

[FIG. 9] Examples of display screens brought up while reproducing an electronic album in a third embodiment

[FIG. 10] An example of a display screen brought up while reproducing an electronic album in a fourth embodiment p [FIG. 11] An example of a display screen brought up while reproducing an electronic album in a fifth embodiment

[FIG. 12] An example of a display screen brought up in response to a flick operation performed while reproduction of image data A1 is in progress

[FIG. 13] An example of a display screen brought up in response to a flick operation performed while reproduction of image data A3 is in progress

[FIG. 14] Examples of display screens brought up while reproducing an electronic album in variation 7

[FIG. 15] Examples of display screens brought up while reproducing an electronic album in variation 8

[FIG. 16] A schematic diagram illustrating data stored in the storage device 30

[FIG. 17] A schematic block diagram illustrating the structure of a portable device 7

[FIG. 18] A schematic diagram illustrating the structure of schedule data 720

[FIG. 19] Examples of display screens brought up while reproducing an electronic album

[FIG. 20] A flowchart of reproduction processing

[FIG. 21] A schematic block diagram illustrating the structure of a portable device 7

[FIG. 22] Examples of display screens brought up while reproducing an electronic album

[FIG. 23] A schematic block diagram illustrating the structure of a portable device 7

[FIG. 24] A schematic diagram illustrating data stored in the storage device 30

[FIG. 25] Examples of display screens brought up while reproducing an electronic album

[FIG. 26] Examples of display screens brought up while reproducing an electronic album

[FIG. 27] Examples of display screens brought up while reproducing an electronic album

[FIG. 28] Examples of display screens brought up while reproducing an electronic album

### DESCRIPTION OF EMBODIMENTS

### First Embodiment

FIG. 1 is a block diagram illustrating the configuration of an image reproduction system achieved in the first embodiment. An image reproduction system 1 is configured with a network 2, a server 3, an information terminal 4, a camera 5a, a camera 5b, a wireless relay station 6a, a wireless relay station 6b and a portable device 7. It is to be noted that the camera 5a and the camera 5b may each be generically referred to as a camera 5 in the following description.

The image reproduction system 1 allows a photographic image captured with the camera 5 to be reproduced on the portable device 7. The network 2 is a wide-area network such as the Internet. The server 3, the information terminal 4, the wireless relay station 6a and the wireless relay station 6b are connected to the network 2. The information terminal 4 may be, for instance, a personal computer or the like. Image data can be transmitted from the camera 5a to the server 3 via the information terminal 4 and the network 2.

The wireless relay station 6a and the wireless relay station 6b are engaged in wireless communication via means such as wireless LAN, with the camera 5b and the portable device 7 respectively. Image data can be transmitted from the camera 5b to the server 3 via the wireless relay station 6a and the network 2. Image data transmitted from the server 3 can be received at the portable device 7 via the wireless relay station 6b and the network 2.

The server 3 includes a storage device 30. The storage device 30 may be constituted with, for instance, an HDD or the like. At the server 3, image data received from the camera 5a and the camera 5b are stored into the storage device 30. The server 3 transmits various types of data stored in the storage device 30 to the portable device 7 as needed.

FIG. 2 schematically illustrates data stored in the storage device 30. A plurality of sets of image data 31 and a plurality of sets of electronic album data 32 are stored in the storage device 30. The image data 31 are image files created in the camera 5 in, for instance, the JPEG format. Each set of image data 31 in the embodiment is an image file with a still image recorded therein. At least one set of category data 33 is correlated to a set of image data 31.

Category data 33 indicate at least one category related to a set of image data 31. Such categories include, for instance, subject attribute categories, such as “automobile”, “mountain”, “animal” and the like, photographing time (e.g., seasons, time blocks) categories “spring”, “nighttime” and the like, photographing location categories “town”, “Japan”, “Tokyo” and the like, and photographic composition categories “landscape”, “portrait” and the like. However, these categories simply represent examples and various aspects related to the image data 31 can be used as categories indicated by the category data 33. In the following description, a set of image data 31 correlated to category data 33 indicating a given category will be referred to as image data 31 belonging to the particular category.

A set of electronic album data 32 expresses an electronic album. A plurality of sets of image data 31 are correlated to a set of electronic album data 32. The user is able to create and edit electronic album data 32 by, for instance, operating the information terminal 4. The user selects a plurality of sets of image data 31 and creates a set of electronic album data 32 to which the selected image data 31 are correlated. In the following description, image data 31 correlated to a set of electronic album data 32 will be referred to as image data 31 included in the particular set of electronic album data 32.

The term “user” in this context refers to a person who views images. The user may be a photographer who captures images, an editor who edits images or a person who simply views images.

FIG. 3 is a block diagram schematically illustrating the structure of the portable device 7. The portable device 7 is an information terminal widely referred to as a tablet-type terminal. The portable device 7 includes a control unit (or a controller) 70, a DRAM 71, a flash memory 72, a liquid crystal display 73, a touch panel 74 and a wireless communication module 75.

The control unit 70 is configured with a microprocessor and its peripheral circuits (not shown). The control unit 70 controls the various components of the portable device 7 by executing a specific control program read from the flash memory 72 where the control program is recorded in advance. The DRAM 71 is a primary storage device, whereas the flash memory 72 is an auxiliary storage device. The liquid crystal display 73 is a display device. The touch panel 74 is an input device laminated upon the liquid crystal display unit 73. The wireless communication module 75 is a communication module engaged in wireless data communication with the wireless relay station 6b. The control unit 70 is able to carry out data communication with a node such as the server 3 connected to the network 2, via the wireless communication module 75.

FIG. 4 schematically illustrates the external appearance of the portable device 7. The portable device 7 includes a casing that takes the form of a plate. The liquid crystal display 73 is disposed at one surface of the casing. The touch panel 74 is laminated upon the liquid crystal display 73. As the user touches the display screen of the liquid crystal display 73 with his finger or the like, the touch panel 74 detects the contact position at the display screen. In the following description, various types of operations performed by the user by touching the display screen of the liquid crystal display 73 with his finger or the like will be referred to as touch operations.

The portable device 7 is capable of reproducing an electronic album based upon electronic album data 32 stored in the storage device 30. Reproduction processing executed to reproduce an electronic album will be explained next.

FIG. 5(a) presents an example of an initial screen that may come up on display at the start of electronic album reproduction. A display screen 73a is partitioned in a tile pattern into a first block 100a, a second block 100b, a third block 100c and a fourth block 100d. In the following description, individual blocks such as the first block 100a, the second block 100b, the third block 100c and the fourth block 100d may each be generically referred to as a block 100. The individual blocks 100 each take a rectangular shape, but their sizes and positions vary. It is to be noted that the blocks do not need to take a rectangular shape and may instead take another shape such as a square shape or a trapezoidal shape.

The control unit 70 selects four sets of image data A1, B1, C1 and D1 among the sets of image data 31 included in the reproduction-target electronic album data 32 and displays them respectively in the first block 100a, the second block 100b, the third block 100c and the fourth block 100d. It is to be noted that the sizes and aspect ratios of the sets of image data A1 through D1 do not necessarily match the sizes and aspect ratios of the corresponding display area blocks 100. The control unit 70 processes the image data A1 through D1 as needed so that they can be fitted into the corresponding blocks 100 on display. For instance, the image data A1 to be displayed in the first block 100a may be enlarged or reduced, part of the image data A1 may be cropped or the aspect ratio of the image data A1 may be adjusted by creating a margin around the image data A1.

FIG. 6 illustrates how image data 31 may be selected. The control unit 70 undertaking reproduction processing tallies the sets of image data 31 included in the reproduction-target electronic album data 32 based upon the category data 33. In the example presented in FIG. 6, the number of sets of image data 31 belonging to each category is counted and various categories are sorted in descending order (in the order starting with the category to which the greatest numbers of sets of image data belong).

Through this processing, the control unit 70 identifies the top four categories to which the greatest numbers of sets of image data 31 belong. In the example presented in FIG. 6, the four categories to which the greatest numbers of sets of image data 31 belong are notated as category A, category B, category C and category D.

The control unit 70 selects the image data A1 among the plurality of sets of image data 31 belonging to category A Likewise, it selects the image data B1 among the plurality of sets of image data 31 belonging to category B, selects the image data C1 among the plurality of sets of image data 31 belonging to category C, and selects the image data D1 among the plurality of sets of image data 31 belonging to category D. Four sets of image data A1 through D1 are thus selected.

The control unit 70 displays (reproduces) the selected image data A1, image data B1, image data C1 and image data D1 respectively in the first block 100a, the second block 100b, the third block 100c and the fourth block 100d, as shown in FIG. 5(a). As a result, the four sets of image data A1 through D1 each belonging to a category different from the rest are brought up on display at the display screen 73a.

The user viewing the images (hereafter referred to as the viewer) finds a set of image data 31 (e.g., image data A1) that interests him among the four sets of image data A1 through D1 on display at the display screen 73a. The viewer is able to indicate to the control unit 70 that he is interested in the image data A1 by touching the first block 100a in which the particular image data A1 are displayed. Namely, through this touch operation, the viewer issues a selection instruction to select the image data A1 displayed in the first block 100a.

In response to this touch operation, the control unit 70 adds new blocks, i.e., a fifth block 100e and a sixth block 100f, at the display screen 73a. In the fifth block 100e and the sixth block 100f, other sets of image data A2 and A3 (related image data) related to the image data A1 that interest the viewer, are brought up on display.

FIG. 5(b) presents an example of a display screen 73b that may come up in response to the touch operation performed at the first block 100a in FIG. 5(a). The control unit 70 sets the new blocks, i.e., the fifth block 100e and the sixth block 100f near the first block 100a where the touch operation has been performed. The control unit 70 secures sufficient display area to accommodate the fifth block 100e and the sixth block 100f by reducing the sizes of the existing blocks 100 other than the first block 100a, i.e., the second block 100b, the third block 100c and the fourth block 100d. In other words, the control unit 70 alters the number of blocks 100, along with their shapes, positions and sizes. It is to be noted that the size of the image data B1 displayed in the second block 100b may be reduced to fit into the adjusted second block 100b or the display range for the image data B1 may be reduced while allowing the image data B1 to retain the initial scale. The same principle applies to the third block 100c and the fourth block 100d.

In the newly set fifth block 100e and sixth block 100f, the related image data A2 and A3 related to the image data A1 displayed in the first block 100a are respectively displayed. The control unit 70 displays other sets of image data A2 and A3 belonging to the same category as the image data A1 displayed in the first block 100a, i.e., category A, as related image data in the fifth block 100e and the sixth block 100f.

The viewer is able to perform another touch operation at a block 100 while the display screen 73b in FIG. 5(b) is up on display. For instance, the viewer, finding the image data A2 displayed in the fifth block 100e interesting, may touch the fifth block 100e. Under these circumstances, since the image data A2 belong to category A, the control unit 70 brings up on display a greater number of sets of image data 31 belonging to category A at the display screen 73b in response to the touch operation. However, adding new blocks 100 into the display screen will result in the individual blocks 100 becoming too small. Accordingly, the control unit 70 instead displays sets of image data A4, A5 and A6, belonging to category A, in the second block 100b, the third block 100c and the fourth block 100d, where the image data B1 through D1 belonging to categories different from category A have been displayed thus far. This means that the control unit 70 replaces the image data B1 through D1 displayed in the second block 100b, the third block 100c and the fourth block 100d with the image data A4, A5 and A6 belonging to category A.

FIG. 5(c) presents an example of a display screen 73c that may come up in response to the touch operation performed at the fifth block 100e in FIG. 5(b). The display screen switch from FIG. 5(b) to FIG. 5(c) differs from the display screen switch from FIG. 5(a) to FIG. 5(b) in that the number of blocks 100, the shapes of the blocks 100, the positions of the blocks 100 and the sizes of the blocks 100 all remain unchanged. The control unit 70 displays other sets of image data A4, A5 and A6 belonging to category A, to which the photographic data A2 displayed in the fifth block 100e also belong, respectively in the second block 100b, the third block 100c and the fourth block 100d.

It is to be noted that while the number of blocks 100 and their shapes, positions and sizes remain unchanged as the display screen 73 is switched from that in FIG. 5(b) to that in FIG. 5(c) in the example described above, the present invention is not limited to this example and the shapes, the positions and the sizes of the blocks 100 as well as the number of blocks 100 may change.

As described above, the control unit 70 adjusts both the display mode for the plurality of blocks 100 and the plurality of sets of image data 31 displayed in the plurality of blocks 100 in response to each touch operation performed at a block 100.

In addition, the viewer is able to navigate through pages, e.g., move forward or backward to another page by, for instance, touching the touch panel 74 or operating an operation member (not shown). In response to a page navigating operation performed by the viewer, the control unit 70 replaces the image data currently displayed in the various blocks 100 with other sets of image data 31 while sustaining the current display mode for the plurality of blocks 100. It is to be noted that it is not strictly necessary to make all the sets of image data 31 included in the electronic album available for viewing in response to a page navigating operation. Furthermore, sets of image data 31 to be newly brought up on display in response to a page navigating operation may be determined based upon predetermined priority rankings. Such priority rankings may be determined for numerous sets of image data 31 included in an electronic album through an existing image determination methods such as subject extraction or vertical/horizontal composition.

FIG. 7 presents a flowchart of reproduction processing. In step S10, an instruction for specifying a set of electronic album data 32 to be designated as a reproduction target is input to the control unit 70. The viewer enters, via an input device such as the touch panel 74, the title, the URL or the like of a specific electronic album, required for identification of the particular set of electronic album data 32. In step S20, the control unit 70 receives the reproduction-target electronic album data 32 from the server 3.

In step S30, the control unit 70 selects four sets of image data 31 to be brought up on display in the initial screen, among the sets of image data 31 included in the electronic album data 32. The selection procedure has been explained in specific terms in reference to FIG. 6. In step S40, the control unit 70 brings up on display the four sets of image data 31 selected in step S30 in four blocks 100 such as those shown in FIG. 5(a).

In step S50, the control unit 70 makes a decision as to whether or not a selection instruction for selecting any set of image data among the sets of image data 31 currently on display, has been input. Namely, it makes a decision as to whether or not a touch operation has been performed to select a set of image data among the sets of image data 31 on display. If no selection instruction has been issued, the control unit 70 proceeds to execute the processing in step S100. If, on the other hand, a selection instruction has been input, the control unit 70 proceeds to execute the processing in step S60.

In step S60, the control unit 70 makes a decision as to whether or not the sizes of the existing blocks 100 are equal to or greater than the predetermined size. If the sizes of all the blocks 100 are equal to or greater than the predetermined size, the control unit 70 proceeds to execute the processing in step S70. In step S70, the control unit 70 creates a new block 100 near the block 100 where the touch operation has been performed. In step S80, the control unit 70 brings up on display image data related to the image data 31, with respect to which the touch operation has been performed, in the new block 100. Subsequently, the control unit 70 proceeds to execute the processing in step S100.

If it is decided in step S60 that there is a block 100 smaller than the predetermined size, the control unit 70 proceeds to execute the processing in step S90. In step S90, the control unit 70 brings up on display image data related to the image data 31, with respect to which the touch operation has been performed, in an existing block 100 different from the block 100 where the touch operation has been performed. Subsequently, the control unit 70 proceeds to execute the processing in step S100.

In step S100, the control unit 70 makes a decision as to whether or not a specific reproduction end operation has been performed. If no reproduction end operation has been performed, the control unit 70 proceeds to execute the processing in step S50. If, on the other hand, a reproduction end operation has been performed, the control unit 70 ends the electronic album reproduction processing.

The following advantages and operations are achieved through the embodiment described above.

(1) The control unit 70 executes control so as to display a plurality of sets of image data 31 having been selected individually in a plurality of blocks 100 set at the display screen. The control unit 70 executes control based upon an instruction issued by the viewer so as to adjust both the display mode for the plurality of blocks 100 and the plurality of sets of image data 31. Through these measures, a display device assuring ease of use, which allows the display layout to be adjusted through a simple operation, can be provided.

(2) The control unit 70 adjusts the display mode for the plurality of blocks 100, which is related to the number of blocks 100, their shapes, their positions and their sizes. As a result, a display device assuring ease of use, which allows the display layout to be adjusted through a simple operation, can be provided.

(3) If an instruction issued by the viewer is a selection instruction for selecting a set of image data 31 among the plurality of sets of image data 31, the control unit 70 brings up on display other image data 31 related to the image data 31 indicated in the selection instruction. As a result, a display device assuring ease of use, at which images likely to interest the viewer are brought up on display automatically in a greater number, can be provided.

(4) When bringing up another set of image data 31 on display, the control unit 70 sets a new block 100 in addition to the plurality of blocks 100 and displays the other set of image data 31 in the new block 100. Through these measures, a great number of images likely to interest the viewer can be simultaneously brought up on display.

(5) The viewer issues an instruction by touching the touch panel 74. Thus, a display device assuring ease of use, at which the display layout can be adjusted in response to an intuitive operation, can be provided.

### Second Embodiment

The image reproduction system achieved in the second embodiment has an operation mode different from that described in reference to the first embodiment. The following is an explanation of features distinguishing the image reproduction system achieved in the second embodiment from the image reproduction system achieved in the first embodiment, given in reference to FIG. 8. It is to be noted that components identical to those in the first embodiment are assigned with the same reference signs so as to preclude the necessity for a repeated explanation thereof.

FIG. 8(a) presents an example of an initial screen that may be on display at the start of electronic album reproduction. A display screen 73d is different from the display screen 73a in FIG. 5(a) in that it includes a slider 110 displayed at the bottom of the screen. The slider 110 is a GUI component with an indicator 111 that can be moved to the left or to the right in the screen in response to a touch operation.

At the start of electronic album reproduction, the indicator 111 is positioned at the left end of the screen. The viewer finds a set of image data 31 that interests him among four sets of image data A1, B1, C1 and D1 on display at the display screen 73a. The viewer is able to set the particular set of image data 31 in a selected state by touching the block 100 in which the particular set of image data 31 is displayed. The plurality of sets of image data 31 cannot enter a selected state simultaneously. If a touch operation is performed for another set of image data 31 while a set of image data 31 has already been selected, the selection of the first set of image data 31 is cancelled and the second set of image data 31 is set in a selected state. The viewer is able to indicate to the control unit 70 that he is interested in a given set of image data 31 by first setting the particular image data 31 in a selected state and then moving the indicator 111 in the slider 110 toward the right side of the screen. Namely, a selection instruction for selecting a set of image data displayed in a block 100 is issued by performing a touch operation in response to which the particular image data 31 are set in a selected state and touch operation through which the indicator 111 is moved to the right in the screen.

The control unit 70 displays the selected block 100 in the screen by switching to a display mode different from that for the other blocks 100, so as to indicate to the viewer that the block 100 is in a selected state. In the example presented in FIG. 8(a), the first block 100a is shaded. This indicates that the first block 100a is in a selected state. However, the present invention is not limited to this example and any of various methods such as flashing the first block 100a, framing the first block 100a with a line having a different thickness or color and superimposing a symbol, e.g., a cursor or an icon, over the first block 100a on display, may be adopted to indicate that the block 100 is in a selected state.

The viewer is able to indicate the level of his interest in the selected image data 31 in correspondence to the extent to which he moves the indicator 111. Namely, the viewer moves the indicator 111 further to the right to indicate greater interest in the selected image data 31. The control unit 70 adds a greater number of sets of related image data to the display screen as the indicator 111 is moved to a greater extent.

FIG. 8(b) presents an example of a display screen 73e that may come up after the indicator 111 in FIG. 8(a) is moved to the right by a predetermined extent ml at the screen. In this situation, the control unit 70 sets new blocks, i.e., a fifth block 100e and a sixth block 100f near the first block 100a in the selected state. The control unit 70 secures sufficient display area to accommodate the fifth block 100e and the sixth block 100f by reducing the sizes of the existing blocks 100 other than the first block 100a, i.e., the second block 100b, the third block 100c and the fourth block 100d. In other words, the control unit 70 alters the number of blocks 100, along with their shapes, positions and sizes.

In the newly set fifth block 100e and sixth block 100f, related image data, i.e., image data related to the image data A1 displayed in the first block 100a are individually displayed. The control unit 70 displays other sets of image data A2 and A3 belonging to the same category as the image data A1 displayed in the first block 100a, i.e., category A, as the related image data in the fifth block 100e and the sixth block 100f.

FIG. 8(c) presents an example of a display screen 73f that may come up after the indicator 111 in FIG. 8(a) is moved to the right by a predetermined extent m2 at the screen. The predetermined extent m2 is greater than the predetermined extent m1 in the example presented in FIG. 8(b). In this situation, the control unit 70 brings up on display the image data A2 and image data A3 by creating new blocks, i.e. the fifth block 100e and the sixth block 100f set near the selected first block 100a and also displays sets of image data A4, A5 and A6 belonging to category A in the existing second block 100b, third block 100c and fourth block 100d respectively. In other words, the control unit 70 displays a greater number of sets of related image data at the screen compared to the number of sets of related image data in FIG. 8(b).

As described above, the control unit 70 adjusts both the display mode for the plurality of blocks 100 and the plurality of sets of image data 31 displayed in the plurality of blocks 100 each time the slider 110 is operated after setting a given block 100 in a selected state.

The following advantages and operations are achieved through the embodiment described above.

(6) The control unit 70 executes control so as to display a plurality of sets of image data 31 having been selected individually in a plurality of blocks 100 set at the display screen. The control unit 70 executes control based upon an instruction issued by the viewer so as to adjust the display mode for the plurality of blocks 100 and the plurality of sets of image data 31. Through these measures, a display device assuring ease of use, which allows the display layout to be adjusted through a simple operation, can be provided.

(7) The control unit 70 adjusts the display mode for the plurality of blocks 100, which is related to the number of blocks 100, their shapes, their positions and their sizes. As a result, a display device assuring ease of use, which allows the display layout to be adjusted through a simple operation, can be provided.

(8) If an instruction issued by the viewer is a selection instruction for selecting a set of image data 31 among the plurality of sets of image data 31, the control unit 70 brings up on display other image data 31 related to the image data 31 indicated in the selection instruction. As a result, a display device assuring ease of use, at which images likely to interest the viewer are brought up on display automatically in a greater number, can be provided.

(9) When bringing up another set of image data 31 on display, the control unit 70 sets a new block 100 in addition to the plurality of blocks 100 and displays the other set of image data 31 in the new block 100. Through these measures, a great number of images likely to interest the viewer can be simultaneously brought up on display.

(10) The viewer issues an instruction by performing a touch operation to indicate a specific set of image data 31 and by performing a touch operation at the slider 110. Thus, a display device assuring ease of use, at which the layout can be adjusted in response to an intuitive operation, can be provided.

### Third Embodiment

The image reproduction system achieved in the third embodiment has an operation mode different from those described in reference to the preceding embodiments. The following is an explanation, of features distinguishing the image reproduction system achieved in the third embodiment from the image reproduction systems achieved in the embodiments described earlier, given in reference to FIG. 9. It is to be noted that components identical to those in the first embodiment are assigned with the same reference signs so as to preclude the necessity for a repeated explanation thereof.

The initial screen that comes up at the start of electronic album reproduction is the display screen 73a such as that shown in FIG. 5(a). The viewer finds a set of image data 31 that interests him among the four sets of image data A1, B1, C1 and D1 on display at the display screen 73a. The viewer is able to set the particular set of image data 31 in a selected state by touching the block 100 in which the particular set of image data 31 is displayed, as in the second embodiment.

FIG. 9(a) presents an example of a display screen 73g that may come up immediately after a set of image data 31 is set in a selected state. Once the set of image data 31 has been selected, the control unit 70 brings up a pop-up display of an operation panel 120a superimposed over the display screen.

FIG. 9(b) illustrates the operation panel 120a. A total of nine square buttons 121 are arranged in a 3×3 array at the operation panel 120a. The buttons 121 are each correlated to a specific display setting. In response to a touch operation performed by the viewer at one of the buttons 121, the control unit 70 applies a display setting corresponding to the particular button 121 to the screen display.

The display settings in the example presented in FIG. 9(b) each represent a specific combination of a number of blocks 100 to be simultaneously displayed at the screen and a number of pages in the electronic album. Namely, a specific combination of the number of blocks 100 and the number of pages is correlated to each button 121, and as the viewer performs a touch operation at one of the buttons 121, the number of blocks 100 and the number of pages change. When a touch operation is performed at one of the buttons 121, the display of the operation panel 120a is terminated.

The number of blocks 100 can be adjusted along the left/right direction in the operation panel 120a. The number of blocks 100 corresponding to a button 121 located further to the left at the operation panel 120a is smaller, whereas the number of blocks 100 corresponding to a button 121 located further to the right at the operation panel 120a is greater. The number of pages in the electronic album can be adjusted along the up/down direction in the operation panel 120a. The number of pages corresponding to a button 121 located further toward the bottom of the operation panel 120a is smaller, whereas the number of pages corresponding to a button 121 located further toward the top of the operation panel 120a is greater.

The viewer selects a button 121 to touch in correspondence to the level of interest he holds for image data related to the selected image data 31. For instance, if his interest is high and he wishes to view a greater number of sets of related image data, he simply needs to touch a button 121 located on the right side of the operation panel 120a. In response to this touch operation, the control unit 70 brings up on display related image data in a great number of blocks 100, as shown in FIG. 5(c). The control unit 70 increases the number of blocks 100 if necessary. In addition, if the number of pages is greater, image data 31 other than image data related to the selected image data 31 can be viewed. This means that the viewer, wishing to view more diverse image data 31 simply needs to touch a button 121 located on the top side of the operation panel 120a.

FIG. 9(c) presents an example of a display screen 73h that includes an operation panel 120b different from the operation panel 120a in FIG. 9(b). In response to a predefined panel display operation performed by the viewer while no image data 31 are in a selected state, the control unit 70 brings up a pop-up display of the operation panel 120b, superimposed over the display screen. The predefined panel display operation may be, for instance, a touch operation performed at the touch panel 74 or an operation performed by operating an operation member (not shown).

As does the operation panel 120a such as that in the example presented in FIG. 9(b), the operation panel 120b includes a total of nine buttons 121. The titles of the categories indicated by the category data 33 in the electronic album are each indicated at one of the buttons 121. The nine alphabet letters A through I in FIG. 9(c) are, in fact, category titles, such as “person” and “moving automobile”.

The viewer selects a button 121 to touch based upon the levels of his interest in the various categories on display. The control unit 70 adjusts the display screen so as to display a greater number of sets of image data 31 belonging to the category corresponding to the button having been touched. For instance, the viewer may have touched the button 121 bearing the category title “A” and in such a case, the control unit 70 adjusts the screen display so as to display a greater number of sets of image data 31 belonging to category A. The control unit 70 increases the number of blocks 100 as needed. For instance, if the number of sets of image data 31 belonging to category A is greater relative to the numbers of sets of image data 31 belonging to other categories, the control unit 70 increases the number of blocks 100. If, on the other hand, the number of sets of image data 31 belonging to category A is smaller relative to the numbers of sets of image data 31 belonging to the other categories, it reduces the number of blocks 100.

As described above, the control unit 70 adjusts both the display mode for the plurality of blocks 100 and the plurality of sets of image data 31 displayed in the plurality of blocks 100 each time the operation panel 120a or 120b is operated.

The following advantages and operations are achieved through the embodiment described above.

(11) The control unit 70 executes control so as to display a plurality of sets of image data 31 having been selected individually in a plurality of blocks 100 set at the display screen. The control unit 70 executes control based upon an instruction issued by the viewer so as to adjust both the display mode for the plurality of blocks 100 and the plurality of sets of image data 31. Through these measures, a display device assuring ease of use, which allows the display layout to be adjusted through a simple operation, can be provided.

(12) The control unit 70 adjusts the display mode for the plurality of blocks 100, which is related to the number of blocks 100, their shapes, their positions and their sizes. As a result, a display device assuring ease of use, which allows the display layout to be adjusted through a simple operation, can be provided.

(13) If an instruction issued by the viewer is a selection instruction for selecting a specific category among the plurality of categories, the control unit 70 brings up on display other image data 31 related to the category indicated in the selection instruction, which are different from the plurality of sets of image data 31 currently on display. As a result, a display device assuring ease of use, at which images likely to interest the viewer are brought up on display automatically in a greater number, can be provided.

(14) When bringing up another set of image data 31 on display, the control unit 70 sets a new block 100 in addition to the plurality of blocks 100 and displays the other set of image data 31 in the new block 100. Through these measures, a great number of images likely to interest the viewer can be simultaneously brought up on display.

(15) The viewer issues an instruction by touching a button 121. Thus, a display device assuring ease of use, at which the display layout can be adjusted in response to an intuitive operation, can be provided.

### Fourth Embodiment

Image data handled in the image reproduction system achieved in each of the embodiments described above are image data 31 having still images recorded therein. The image reproduction system achieved in the fourth embodiment is capable of handling image data 31 having recorded therein video as well as image data 31 having recorded therein still images. The following is an explanation of features distinguishing the image reproduction system achieved in the fourth embodiment from the image reproduction system achieved in the first embodiment, given in reference to FIG. 10. It is to be noted that components identical to those in the first embodiment are assigned with the same reference signs so as to preclude the necessity for a repeated explanation thereof.

The image data 31 in the embodiment include image data 31, having recorded therein still images and image data 31 having video (or moving images) recorded therein. Accordingly, image data 31 in a given set of electronic album data 32 also include still images and video. The control unit 70 sorts blocks 100 into a group of blocks for still image display and a group of blocks for video playback. For instance, it may designate half of the blocks 100 on display at the screen as still image display blocks and the remaining blocks 100 as video playback blocks. As an alternative, it may designate still image display blocks 100, among the blocks 100, at a ratio matching the ratio of the still images in the image data 31 included in the electronic album.

FIG. 10 presents an example of a display screen 73i that may be brought up for electronic album reproduction. It differs from the display screen 73a in FIG. 5(a) in that the first block 100a and the fourth block 100d are designated as video blocks 100. The control unit 70 brings up on display various GUI components needed for video playback control, superimposed over the video blocks 100. In the example presented in FIG. 10, a seek bar 130 and a button 131 are displayed superimposed over the first block 100a and the fourth block 100d. The seek bar 130 is a GUI component via which a video playback position is indicated and set. The button 131 is a GUI component via which the video playback is paused or resumed. The viewer is able to set the video playback position, pause the video playback and resume the video playback by operating these GUI components.

The control unit 70 designates a plurality of sets of image data 31 (video clips) belonging to a specific category to a single video playback block 100. The control unit 70 plays back the plurality of sets of image data 31 (video clips) designated to the block 100 in sequence. In other words, the plurality of sets of image data 31 (video clips) are played back in a single block 100 through time-apportioned play or time-division. Since categories are defined in much the same way as the method through which still image categories are defined as has been described in reference to the first embodiment, a repeated explanation is not provided. Image data 31 (video clips) to be designated to the block 100, may be selected from a plurality of sets of image data 31 (video clips) belonging to the particular category by adopting an image determination method of the known art such as subject extraction or hand shake sensing.

It is to be noted that instead of playing back video clips within a block 100, video clips may be played back over the entire display screen. In such a case, in response to a playback instruction for a specific block 100 entered by the viewer, the control unit 70 will start playing back the plurality of sets of image data designated to the particular block 100 over the entire screen.

In addition, when playing back video clips within a single block 100 through time-apportioned play, a second and subsequent video clips may be played back over a range whose size is smaller than the block 100. For instance, the first video clip may be played back over the entire block 100, whereas the second video clip may be played back over a range which is slightly smaller than the block 100. While the second video clip is being played back, the image in the last frame of the first video clip will remain on display in the periphery of the second video clip. The third video clip may be played back over a range which is even smaller. These measures allow the viewer to see at a glance that a plurality of video clips are designated to the particular block 100.

In this embodiment, too, the viewer is able to indicate to the control unit 70 that he is interested in the image data 31 displayed in a given image block 100 by touching the particular still image block 100. In other words, a selection instruction for the image data 31 displayed in the block 100 is issued through the touch operation. In response to the touch operation, the control unit 70 executes processing similar to that described in reference to the first embodiment. Namely, in response to the touch operation, it adds new blocks 100 to the display screen 73a, as illustrated in FIG. 5(b). Other sets of image data 31 (related image data) related to the image data 31 the viewer is interested in are displayed in the new blocks 100. Otherwise, in response to the touch operation, the image data 31 displayed in the existing blocks 100 are replaced with image data 31 belonging to the category matching the category to which the image data 31 displayed in the block 100 touched by the viewer belong, as illustrated in FIG. 5(c).

Touch operations performed at a video block 100 will be explained. A touch operation performed by the viewer may be a pinch-in operation or a pinch-out operation at the seek bar 130 displayed in a video block 100. The viewer performing a pinch-in operation touches the seek bar 130 with, for instance, two fingers and reduces the distance between the two fingers while sustaining contact with the screen. A pinch-out operation is a touch operation performed by touching the seek bar 130 with two fingers and increasing the distance between the two fingers while sustaining contact with the screen.

As the viewer performs a pinch-out operation at the seek bar 130 in a specific block 100, the control unit 70 increases the number of sets of image data 31 (video clips) designated to the block 100. For instance, in response to a pinch-out operation performed to a predetermined extent at the seek bar 130 in a block 100 to which two sets of image data 31 (video clips) are currently designated, the control unit designates two additional sets of image data 31 (video clips) to the block 100. As a result, the block 100 is designated with a total of four sets of image data 31 (video clips). The sets of image data 31 (video clips) that have been additionally designated to the block 100 are other sets of image data 31 (video clips) belonging to the same category as the category to which the image data 31 (video clips) currently designated to the block 100 belong.

The number of sets of image data 31 (video clips) designated to the block by the control unit 70 corresponds to the extent of the pinch-out operation. Namely, if the viewer performs a pinch-out operation to a great extent, a greater number of sets of image data 31 (video clips) is designated.

It is to be noted that another set of image data 31 (video clip) to be additionally designated may belong to a category different from the category to which the image data 31 (video clips) currently designated to the block 100 belong. For instance, sets of image data A1 and A2 belonging to category A may be designated to a given block 100 with no more image data 31 belonging to category A left in the electronic album data 32 being reproduced. Under these circumstances, an additional set of image data 31 belonging to category A cannot be designated to the block 100. Accordingly, the control unit 70 may instead designate a set of image data 31 belonging to a category other than category A to the block 100. In such a case, it is desirable to designate image data 30 belonging to another category related to category A. In more specific terms, if category A is “train”, it is preferable to designate image data 31 belonging to another category such as “train station” which is closely related to “train”.

As the viewer performs a pinch-in operation at the seek bar 130 in a specific block 100, the control unit 70 executes processing that is the opposite of the processing executed in response to the pinch-out operation described above. Namely, it reduces the number of sets of image data 31 (video clips) designated to the block 100.

It is to be noted that the pinch-out operation and the pinch-in operation may be performed at the block 100 instead of at the seek bar 130.

The following advantages and operations are achieved through the embodiment described above.

(16) The control unit 70 executes control so as to bring up on display a plurality of sets of image data 31 having been selected individually in a plurality of blocks 100 set at the display screen. The control unit 70 executes control based upon an instruction issued by the viewer so as to adjust both the display mode for the plurality of blocks 100 and the plurality of sets of image data 31. Through these measures, a display device assuring ease of use, which allows the display layout to be adjusted through a simple operation, can be provided.

(17) The control unit 70 adjusts the display mode for the plurality of blocks 100, which is related to the number of blocks 100, their shapes, their positions and their sizes. As a result, a display device assuring ease of use, which allows the display layout to be adjusted through a simple operation, can be provided.

(18) If an instruction issued by the viewer is a selection instruction for selecting a set of image data 31 among the plurality of sets of image data 31, the control unit 70 brings up on display other image data 31 related to the image data 31 indicated in the selection instruction. As a result, a display device assuring ease of use, at which images likely to interest the viewer are brought up on display automatically in a greater number, can be provided.

(19) When bringing up another set of image data 31 on display, the control unit 70 sets a new block 100 in addition to the plurality of blocks 100 and displays the other set of image data 31 in the new block 100. Through these measures, a great number of images likely to interest the viewer can be simultaneously brought up on display.

(20) The viewer issues an instruction by touching the touch panel 74. Thus, a display device assuring ease of use, at which the display layout can be adjusted in response to an intuitive operation, can be provided.

(21) The plurality of sets of image data 31 include a plurality of video clips. The control unit 70 designates a plurality of video clips to at least one block 100 among the plurality of blocks 100 and plays back the plurality of video clips in the block 100 through time-apportioned play or time-division. Through these measures, a plurality of video clips can be played back within a limited display space.

(22) If the viewer issues an instruction for selecting a block 100, the control unit 70 adjusts playback of the plurality of video clips by using another video clip related to at least one of the plurality of video clips. These measures make it possible to select an optimal video clip for playback in correspondence to the level of viewer interest.

### Fifth Embodiment

The image reproduction system achieved in the fourth embodiment described above allows the number of video clips designated to a block 100 to be increased or decreased in response to a pinch-in operation or a pinch-out operation. The image reproduction system achieved in the fifth embodiment includes an operation system that enables viewing of even more diverse video clips. The following is an explanation of features distinguishing the image reproduction system achieved in the fifth embodiment from the image reproduction system achieved in the fourth embodiment, given in reference to FIGS. 11 through 13. It is to be noted that components identical to those in the fourth embodiment are assigned with the same reference signs so as to preclude the necessity for a repeated explanation thereof.

FIG. 11 presents an example of a display screen 73j that may come up for electronic album reproduction. Sets of image data A1, A2 and A3, each belonging to category A, for instance, are designated to the block 100a. The image data A1 belong to category B as well as to category A. The image data A2 belong to category A alone. The image data A3 belong to category C as well as to category A. The electronic album data 32 being reproduced also include other sets of image data B1 and B2 which are video clips belonging to category B and other sets of image data C1, C2 and C3 which are video clips belonging to category C.

When there are other video clips related to the video clips designated to the block 100a, as described above, the control unit 70 displays a related image appeal operation component 140 in the block 100a. The related image appeal operation component 140 is a horizontally elongated GUI component displayed over the boundary separating the first block 100a from the second block 100b and the third block 100c. The related image appeal operation component 140 is an index that indicates the presence of other image data related to the image data 31 currently designated to the first block 100a. The viewer is able to ascertain that there are image data related to those in the first block 100a by visually checking the related image appeal operation component 140.

The viewer is able to perform a type of touch operation referred to as a flick operation at the related image appeal operation component 140 by flicking the related image appeal operation component 140. A flick operation is a touch operation performed by touching the related image appeal operation component 140 with a finger and moving the finger, for instance, downward on the screen while sustaining contact.

FIG. 12 presents an example of a display screen 73k that may come up in response to a flick operation performed at the related image appeal component 140 while the image data A1 are being played back in the first block 100a. In response to a flick operation, the control unit 70 sets new blocks i.e., a fifth block 100e and a sixth block 100f, under the first block 100a. The control unit 70 secures sufficient display area to accommodate the fifth block 100e and the sixth block 100f by reducing the sizes of the existing blocks 100 other than the first block 100a, i.e., the second block 100b, the third block 100c and the fourth block 100d. In other words, the control unit 70 alters the number of blocks 100, along with their shapes, positions and sizes. The related image appeal operation component 140 moves to the boundary separating the fifth block 100e and the sixth block 100f from the second block 100b and the third block 100c.

If the flick operation has been performed during playback of the image data A1 in the first block 100a, the control unit 70 designates the image data B1 and B2 belonging to category B to the new blocks i.e., the fifth block 100e and the sixth block 100f respectively. Namely, in response to a flick operation performed at the related image appeal operation component 140, the control unit 70 adds a new block 100 at the display screen and designates another set of image data 31 (video clip) to the new block 100. The other set of image data 31 (video clip) to be designated to the new block is related image data, which are related to the image data 31 (video clip) being played back in the block 100 corresponding to the related image appeal operation component 140.

FIG. 13 presents an example of a display screen 731 that may come up in response to a flick operation performed at the related image appeal component 140 while the image data A3 are being played back in the first block 100a. In response to a flick operation, the control unit 70 sets new blocks i.e., a fifth block 100e. a sixth block 100f and a seventh block 100g, under the first block 100a.

If a flick operation has been performed during playback of the image data A3 in the first block 100a, the control unit 70 designates the image data C1, C2 and C3 belonging to category C to the new blocks i.e., the fifth block 100e, the sixth block 100f and the seventh block 100g respectively. Namely, in response to a flick operation performed at the related image appeal operation component 140, the control unit 70 adds a new block 100 at the display screen and designates another set of image data 31 (video clip) to the new block 100. The other set of image data 31 (video clip) to be designated to the new block is related image data, which are related to the image data 31 (video clip) being played back in the block 100 corresponding to the related image appeal operation component 140.

It is to be noted that no flick operation is accepted at the related image appeal operation component 140 while the image data A2 with no image data related thereto are being played back in the first block 100b. In this situation, the display mode for the related image appeal operation component 140 or the first block 100b may be altered so as to let the viewer know that there are no related image data. For instance, the intensity of the display color for the related image appeal operation component 140 may be lessened. The display mode adopted for the related image appeal operation component 140 may be used as another type of indicator as well. For instance, the color tone of the related image appeal operation component 140 may be altered to indicate whether or not a particular set of related image data has already been viewed.

In addition, instead of designating related image data to a new block 100 created by reducing the sizes of the existing blocks 100, the related image data may be directly designated to an existing block 100. For instance, the image data B1 and the image data B2 may be respectively designated to the second block 100b and the third block 100c at the display screen 73j in FIG. 11(a).

The following advantages and operations are achieved through the embodiment described above.

(23) The control unit 70 executes control so as to bring up on display a plurality of sets of image data 31 having been selected individually in a plurality of blocks 100 set at the display screen. The control unit 70 executes control based upon an instruction issued by the viewer so as to adjust both the display mode for the plurality of blocks 100 and the plurality of sets of image data 31. Through these measures, a display device assuring ease of use, which allows the display layout to be adjusted through a simple operation, can be provided.

(24) The control unit 70 adjusts the display mode for the plurality of blocks 100, which is related to the number of blocks 100, their shapes, their positions and their sizes. As a result, a display device assuring ease of use, which allows the display layout to be adjusted through a simple operation, can be provided.

(25) If an instruction issued by the viewer is a selection instruction for selecting a set of image data 31 among the plurality of sets of image data 31, the control unit 70 brings up on display other image data 31 related to the image data 31 indicated in the selection instruction. As a result, a display device assuring ease of use, at which images likely to interest the viewer are brought up on display automatically in a greater number, can be provided.

(26) When bringing up another set of image data 31 on display, the control unit 70 sets a new block 100 in addition to the plurality of blocks 100 and displays the other set of image data 31 in the new block 100. Through these measures, a great number of images likely to interest the viewer can be simultaneously brought up on display.

(27) The viewer issues an instruction by touching the touch panel 74. Thus, a display device assuring ease of use, at which the display layout can be adjusted in response to an intuitive operation, can be provided.

(28) The plurality of sets of image data 31 include a plurality of video clips. The control unit 70 designates a plurality of video clips to at least one block 100 among the plurality of blocks 100 and plays back the plurality of video clips in the block 100 through time-apportioned play. Through these measures, a plurality of video clips can be played back within a limited display space.

(29) If the viewer issues an instruction for selecting a block 100, the control unit 70 adjusts playback of the plurality of video clips by using another video clip related to at least one of the plurality of video clips. These measures make it possible to select an optimal video clip for playback in correspondence to the level of viewer interest.

(30) For at least one block 100 among the plurality of blocks 100, related image data, related to the image data 31 displayed in the particular block 100, may be available. In such a case, the control unit 70 brings up on display the related image appeal operation component 140 which functions as an index that indicates the presence of such related image data. As a result, the viewer is able to ascertain with ease the presence of any related image data.

(31) In response to a flick operation performed by the viewer while the related image appeal operation component 140 is up on display, the control unit 70 adds a new block 100 and displays related image data in the new block 100. As a result, a display device assuring ease of use, which allows related image data to be viewed through a simple operation, can be provided.

(32) The control unit 70 displays the related image appeal operation component 140 over the boundary separating the block 100 corresponding to the related image appeal operation component 140 from another block 100 adjacent to the particular block 100. The control unit 70 adds a new block 100 at the boundary area in response to a flick operation performed by the viewer and displays related image data in the new block 100. Through these measures, a display device assuring ease of use, at which sets of image data 31 related to each other are played back at positions near to each other, can be provided.

One of the following variations or a plurality of the following variations may be adopted in combination with any of the first through fifth embodiments described above.

### (Variation 1)

The priority rankings based upon which image data 31 are displayed in blocks 100 may be determined through a method other than that explained in reference to FIG. 6. For instance, the duration of past viewing and the number of past views may be recorded in correspondence to each set of image data 31 viewed by the viewer, and priority rankings may be determined based upon the viewing durations and the past view counts. As an alternative, priority rankings may be determined by analyzing viewer's interest through SNS or the like.

The sizes and the like of blocks 100, as well as priority rankings, may be determined based upon past viewing durations and the past view counts. For instance, the size of a block 100 where frequently viewed image data 31 are displayed may be increased relative to the sizes of the other blocks 100. The size of the block 100 where frequently viewed image data 31 are displayed may instead be reduced relative to the sizes of the other blocks 100.

The video playback duration over which a video clip is played back may also be determined based upon the information explained above. For instance, while image data 31 (video clip) that have never been viewed by the viewer may be played back in their entirety, only a portion (e.g., an essential portion) may be played back for image data 31 (video clip) that have already been viewed several times. As an alternative, frequently viewed image data 31 (video clip) may be played back over a longer playback duration compared to other image data 31 (video clips).

The following advantage and operation are achieved through the variation described above.

(33) The control unit 70 adjusts both the display mode for the plurality of blocks 100 and the plurality of sets of image data 31 based upon a history indicating the viewing duration and the view count recorded in correspondence to each set of image data 31 viewed by the viewer in the past. As a result, a display device that is optimized for each viewer can be provided.

### (Variation 2)

Priority rankings with which image data 31 are displayed in blocks 100 may be determined based upon an edit history recorded in correspondence to each set of image data 31. Before a set of image data 31 is transmitted to the server 3, for instance, the image data 31 can be processed/edited by using a photo editing (or retouching) software program or a video editing software program. In this variation, information pertaining to any processing (editing) is also transmitted to the server 3 together with the image data 31. The control unit 70 may display image data 31 by giving higher priority to a set of image data 31 having undergone a greater number of processing (editing) sessions.

The following advantage and operation are achieved through the variation described above.

(34) The control unit 70 selects a plurality of sets of image data 31 by giving higher priority to a set of image data 31 having undergone a greater number of editing operations in the past. As a result, higher quality image data 31, resulting from more rigorous editing by an editor, can be made available with priority for viewing by the viewer.

### (Variation 3)

In the embodiments described earlier, the portable device 7 is operated by performing touch operations at the touch panel 74. In other words, instructions issued by the viewer are invariably input to the control unit 70 through touch operations performed at the touch panel 74. Instead of such touch operations, the viewer may perform operations at another operation member (e.g., a mechanical switch).

In addition, touch operations may be replaced with predetermined movements made by the viewer detected by various types of sensors. For instance, the viewer's line of sight may be detected by an image capturing device and a change in the sight line may be used as an instruction issued by the viewer. As an alternative, a hand gesture made by the viewer may be detected via an infrared sensor or the like and a predetermined hand gesture may be regarded as an instruction. Moreover, the voice of the viewer may be detected through a microphone and a predetermined sound may be regarded an instruction.

The following advantage and operation are achieved through the variation described above.

(35) The viewer issues an instruction by making a predetermined body movement which is detected via a predetermined sensor. Through these measures, a display device enabling more intuitive operation can be provided.

### (Variation 4)

The viewer performs a pinch-in operation or a pinch-out operation to increase or decrease the number of video clips designated to a given block 100 in the fourth embodiment. A pinch-in operation or a pinch-out operation may instead be performed to increase/decrease a currently allocated video clip playback duration. For instance, the playback duration may be limited in advance to one minute for each video clip. The viewer may perform a pinch-out operation at the seek bar 130 in a given block 100 so as to increase the duration to two minutes or three minutes from one minute. In contrast, the playback duration may be reduced to 50 seconds or 40 seconds, in response to a pinch-out operation. In addition, instead of increasing or decreasing playback duration for all the video clips designated to the particular block 100, the playback duration for the video clip currently being played back may be increased or decreased.

### (Variation 5)

While the portable device 7 is configured as a tablet terminal in each of the embodiments described above, the present invention may be adopted in conjunction with a terminal in another form. For instance, the portable device may be a smart phone. The portable device 7 may be any of various types of terminals with varying screen sizes, and in such a case, the number of blocks 100 displayed at the screen may be adjusted in correspondence to the screen size.

### (Variation 6)

The operating methods and display methods described above simply represent examples and the present invention may adopt an operating method or display method different from those. For instance, as the viewer touches specific image data 31, additional blocks 100 are set so as to display image data related to the particular image data 31 in the additional blocks 100 in the first embodiment. As an alternative, a pinch-in operation or a pinch-out operation may be performed with regard to the specific image data 31. In such a case, the number of blocks 100 is increased in response to a pinch-out operation so as to display image data related to the image data 31 in the additional blocks 100. If, on the other hand, a pinch-in operation is performed, the number of blocks 100 is reduced. In another example of a variation for the operating method, outcomes of the pinch-in operation and the pinch-out operation may be reversed, or the positions taken by the indicator 111 to indicate specific settings along the left/right direction may be reversed.

### (Variation 7)

The operating methods and display methods described above simply represent examples and the present invention may adopt an operating method or display method different from those. For instance, as the viewer touches an image B1 among images A1, B1, C1 and D1 displayed in various blocks, as shown in FIG. 14, the block where the image C1 is currently displayed may be partitioned into two blocks so as to display images B2 and B3 related to the image B1 and the block where the image D1 is currently displayed may be partitioned into two blocks so as to display the images C1 and D1 without making any alterations to the display images A1 and B1. As the viewer then touches the image B1 (or the image B2 or B3), more images related to the image B1 may be brought up on display.

### (Variation 8)

The operating methods and display methods described above simply represent examples and the present invention may adopt an operating method or display method different from those. For instance, while images A1, B1, C1 and D1 are displayed in various blocks, as shown in FIG. 15, the viewer may be allowed to fix or lock a desired image and alter the block partitioning and image display with regard to the display areas of the blocks where other images are displayed. The viewer, interested in the images A1 and D1, for instance, locks these images so that they will not be changed. An image may be locked by holding down on the image so as to append a lock (key) mark, to distinguish it from images that are not locked, or by double tapping the image so as to append a lock (key) mark thereto. Once a lock (key) mark is appended to an image by the viewer, the image remains unchanged even if the block partitioning or the other display images subsequently change. The viewer clears the lock (key) mark appended to the image in order to subject the block corresponding to the particular display image to a block partition change or to delete the image through a subsequent operation. Assuming that the display screen is partitioned into six blocks, one to five blocks can be locked by the viewer wishing to lock images, and at least one block that remains unlocked and is subject to change through subsequent processing, i.e., the remaining block can be partitioned into a plurality of blocks and new images can be designated to these blocks.

Furthermore, the viewer may perform an operation as if to, for instance, draw a line through the middle of the block where the display image A1 is displayed, and in response, the block may be split into two blocks and images related to the image A1 may be brought up on display in the newly created two blocks.

### (Other Variations)

While the display modes described in reference to the various embodiments above are assumed in a portable device, the present invention is not limited to applications in a portable device and the display modes may be adopted in any of various display devices such as a tablet terminal, a camera body and a television set that can be operated through touch operations. It is to be noted that while an explanation has been given by assuming that the display device is operated through touch operations, the present invention may be adopted in conjunction with operations other than touch operations, such as mouse operations or button operations at a personal computer, voice instruction operations or line of sight instruction operations, as long as selections can be made through such operations.

In addition, the entire display screen is covered with a plurality of blocks 100 in the embodiments described above. As an alternative, clearances may be provided between the individual blocks 100. Namely, the plurality of blocks 100 do not need to be densely set without any gaps between them over the entire display screen. In another example related to a display method, a display device such as that disclosed in International Patent Publication WO2013/077338, that displays a 3D image in space may be used in place of the liquid crystal display unit 73.

In addition, while an explanation has been given in reference to the various embodiments by assuming that the viewer views the display screen held in a vertical orientation (the term “vertical orientation” will be used to refer to the orientation whereby the longer sides of the display screen extend along the vertical direction and the shorter sides of the display screen extend along the horizontal direction, as shown in FIG. 5), the viewer may instead view the display screen held in a horizontal orientation (the term “horizontal orientation” will be used to refer to the orientation, different from the vertical orientation, whereby the longer sides of the display screen extend along the horizontal direction and the shorter sides of the display screen extend along the vertical direction). The viewer viewing the display screen held in the horizontal orientation is able to operate the display device and display images in much the same way as when he views the display screen held in the vertical orientation. However, the display screen held in the horizontal orientation may be partitioned into blocks differently, with the images brought up on display in a different order, from the partitioning pattern with which display screen is partitioned and the order in which images are brought up on display at the display screen held in the vertical orientation.

In addition, there may be a block where no image is brought up on display when images are displayed in sequence at the display screen. Such a block where no image is on display may indicate that there are no more related images, or the blank block may be utilized as a memo field where the viewer can enter his comments.

Moreover, when the viewer ends image viewing, the blocks set in the last display screen and the details of the display images at the last display screen may be saved into a memory (e.g., an internal memory at the portable device or camera, an external recording medium such as an SD card or recording space in a PC or on the cloud) as a file, or the viewing function may be terminated without saving them. In a file saving mode, both the images displayed at the last display screen and the blocks set in the last display screen may be saved, or only either the images displayed in the last display screen or the blocks set in the last display screen may be saved. By saving details of the last display screen, the viewer is able to resume viewing by selecting the saved file in the memory. For instance, the viewer, having saved both the images on display at the last display screen and the blocks set in the last display screen, simply needs to select the saved file in order to bring up on display the screen he finished viewing. In addition, if the viewer saves only the blocks set in the last display screen and selects the specific block partition having been thus saved, the display screen will be partitioned into blocks having the same partition pattern and arbitrary images will be designated to and displayed in these blocks. If, on the other hand, the viewer saves only the images having been on display in the last display screen and these images are read out from the saved image file, the display screen will be partitioned into blocks optimal for the number of images and the images will be displayed in these blocks. As an alternative, the images having been saved may be brought up on display in sequence one at a time.

Furthermore, as the viewer continuously views images, the sizes of blocks displayed at the display screen may gradually become smaller until display images designated to the individual blocks cannot be viewed with ease. As a means for addressing this problem, a limit may be set with respect to block sizes. The limit (smallest block size limit) to block sizes may be set by the viewer or it may be set in advance at the display device based upon the size of the display screen. For instance, if some images have been locked as in variation 8 described earlier, the display area where display images and blocks can be adjusted becomes smaller and the size of a block is bound to reach the limit, i.e., the smallest block size limit, after only a few viewer operations. An upper limit to block sizes may also be set and a block taking the largest block size may occupy the entire display screen so that a single image can be displayed at the display screen.

If an image that does not interest the viewer is displayed in the initial display screen, the viewer may remove the image by performing, for instance, a slide operation.

Furthermore, the viewer, wishing to display one of the display images in an enlargement, is able to enlarge the image by performing a touch operation or a slide operation at the image. In such a case, once the enlarged display ends, the initial screen prior to the enlarging operation (with the display images and the blocks in the initial screen) is resumed.

It is to be noted that the viewer may perform an operation as if to partition a given block (e.g., draw a line) so as to partition the block into smaller blocks separated from each other by the line and display images in the individual blocks.

Operations other than touch operations may be performed at the display screen. The following is an explanation of specific examples of such alternative operations.

FIG. 25 presents examples of display screens that may come up on display in a variation. It is assumed that a display screen 730a in FIG. 25(a), for instance, is up on display initially. Five blocks are set at the display screen 730a. Image data A1 belonging to category A, image data B1 belonging to category B, image data C1 belonging to category C, image data D1 belonging to category D and image data E1 belonging to category E are individually displayed in the five blocks.

As the viewer holds down on the image data A1 (i.e., the block where the image data A1 are displayed) over a first duration (e.g., 3 seconds) the control unit 70 switches from the display screen 730a to a display screen 730b shown in FIG. 25(b). Namely, the blocks as a whole are compressed toward the left side of the screen, with a vertically elongated area 731 set on the right side of the screen. Four blocks where image data A2, image data A3, image data A4 and image data A5 are to be displayed are newly set in the area 731. These four sets of image data A2 through A5 are image data related to the image data A1 having been indicated by the viewer through the hold-down operation.

As the viewer holds down on the image data A1 again over the first duration at the display screen 730b shown in FIG. 25(b) the control unit 70 switches from the display screen 730b to a display screen 730c shown in FIG. 25(c). Namely, the existing blocks in the area 731 set on the right side of the screen are all slightly compressed toward the top side of the screen and four new blocks are set below these blocks. Sets of image data A6, A7, A8 and A9, which are image data related to the image data A1 having been indicated by the viewer through the hold-down operation, are individually brought up on display in the additional four blocks.

Thus, each time the viewer holds down on a given set of image data over the first duration, the number of sets of related image data displayed in the area 731 increases.

As the viewer presses down on the image data A1 displayed at the display screen 730a in FIG. 25(a) over a second duration (e.g., five seconds) longer than the first duration, the control unit 70 switches from the display screen 730a to a display screen 730c shown in FIG. 25(c). Namely, in response to a viewer operation performed by holding down on the image data over the second duration, the control unit 70 brings up on display the display screen 730c, which is otherwise brought up if the viewer holds down on the image data over the first duration twice in a row.

It is to be noted that the display screen 730b in FIG. 25(b) or the display screen 730c in FIG. 25(c) may be brought up on display in response to an operation other than a hold-down operation. For instance, the viewer may perform a two-point simultaneous touch operation (an operation performed by contacting the screen with two fingers) at the display screen 730a and in response, the control unit 70 may switch from the display screen 730a to the display screen 730b shown in FIG. 25(b). Instead of a two-point simultaneous touch operation, the viewer may perform a two-point flick operation (an operation performed by moving two fingers along any direction at the screen while sustaining the two-finger contact with the screen).

As the viewer touches the image data A1 at the display screen 730a in FIG. 25(a), the control unit 70 switches from the display screen 730a to a display screen 730d shown in FIG. 25(d). Namely, the blocks where the image data B1, the image data C1, the image data D1 and the image data E1 are displayed are compressed toward the bottom side of the screen and three new blocks are set below the block where the image data A1 are displayed. Image data A2, A3 and A4 expressing images related to the image data A1 having been touched by the viewer are displayed in the three blocks.

Thus, the number of sets of related image data brought up on display increases each time the viewer performs a touch operation.

A display screen 730e in FIG. 25(e) comes up in response to a viewer operation performed by touching the image data A1 a few times while the display screen 730d shown in FIG. 25(d) is up. At the display screen in FIG. 25(e), the blocks present in FIG. 25(d) are compressed so as to take up a smaller area compared to the area they occupy in FIGS. 25(d) and 11 new blocks are additionally set. Image data A5, A6, A7, A8, A9, A10, A11, A12, A13, A14 and A15, which are image data related to the image data A1 having been touched by the viewer repeatedly, are displayed in these 11 blocks.

As described above, each time the viewer touches the image data A1, the control unit 70 adds new blocks, in which image data related to the image data A1 are to be displayed at the display screen. Once the size of any block (or a predetermined number or more of blocks) has reached a predetermined smallest size limit, the control unit 70 no longer adds any more blocks at the display screen even if the viewer performs another touch operation. The control unit 70 instead replaces the image data displayed in the existing blocks with other image data.

For instance, the size of a given block at the display screen 730e shown in FIG. 25(e) may have reached the predetermined smallest size limit. Under these circumstances, as the viewer touches the image data A1, the control unit 70 switches from the display screen 730e to a display screen 730f shown in FIG. 25(f). In this screen display, the image data A4 through A7 displayed in the four blocks arranged in a lateral row are replaced with image data A16, A17, A18 and A19, which are image data related to the image data A1.

In addition, after the size of a given block at the display screen 730e shown in FIG. 25(e) has reached the predetermined smallest size limit. The viewer may touch, for instance, the image data B1. In this case, the control unit 70 switches from the display screen 730e to a display screen 730g shown in FIG. 25(g). In this screen display, the image data A4 through A7 displayed in the four blocks arranged in a lateral row are replaced with image data B2, B3, B4 and B5, which are image data related to the image data B1.

It is to be noted that display images may be switched with a pattern different from either of the patterns illustrated in FIG. 25(f) and FIG. 25(g). For instance, instead of replacing the image data A4 through A7 with other sets of image data, the image data A8 through A11 may be replaced with other sets of image data. In addition, the display content in blocks other than four blocks set along a lateral row may be altered.

As a further alternative, in response to a touch operation performed by the viewer by touching the image data B1 after the size of a block has reached the smallest size limit, the control unit 70 may remove all the blocks where the related image data pertaining to the image data A1 are displayed from the display screen and add blocks where image data related to the image data B1 are to be brought up on display into the display screen. As yet another alternative, control may be executed so that the number of blocks, the block sizes, the image data displayed in the blocks and the like remain unchanged even if the viewer touches a block once the size of a block has reached the smallest size limit. In this case, the control unit 70 may bring up on display a message indicating that no more blocks can be added.

It is to be noted that while the control unit 70 retains the image data B1, C1, D1 and El on display at all times at the various display screens shown in FIG. 25(b) through 25(g), one set of image data or a plurality of sets of image data among the image data B1, C1, D1 and E1 may be taken off the display when new blocks are added or display image data are switched. In such a case, it is desirable to determine which image data are to be removed from the display based upon, for instance, the levels of viewer interest in the individual sets of image data (i.e., the set of image data in which the viewer is most interested remains on display the longest), the total numbers of sets of related image data included in the electronic album data 32 (i.e., the set of image data having the greatest number of sets of related image data remains on display the longest) or the like.

It is to be noted that the control unit 70 may switch from the display screen 730b in FIG. 25(b) to the display screen 730d in FIG. 25(d), instead of to the display screen 730c in FIG. 25(c) in response to a viewer operation performed by holding down on the image data A1 over the first duration.

Next, the display screen coming up on display as the viewer touches the image data B1 at the display screen shown in FIG. 25(d) will be explained. In response to this touch operation, the control unit 70 switches from the display screen 730d to a display screen 730h shown in FIG. 26(a). Namely, the control unit 70 reduces the sizes of the blocks in which the image data A1 and the sets of image data A2, A3 and A4 related to the image data A1 are displayed and also adds three new blocks where image data B2, B3 and B4 related to the image data B1 having been touched are to be displayed at the display screen. Namely, the control unit 70 displays the image data A1 and the related image data A2, A3 and A4, which have already been viewed, in blocks smaller than the other blocks.

It is to be noted that in response to a viewer operation performed by touching the image data B1 at the display screen shown in FIG. 25(d), the control unit 70 may switch from the display screen 730d to a display screen 730i shown in FIG. 26(b) instead. Namely, the control unit 70 may add two new blocks where image data B2 and B3 related to the image data B1 having been touched are to be displayed at the display screen, while keeping the image data A1 through A4 on display unaltered.

It is to be noted that in response to a viewer operation performed by touching the image data B1 at the display screen shown in FIG. 25(d), the control unit 70 may switch from the display screen 730d to a display screen 730j shown in FIG. 26(c) instead. Namely, the control unit 70 may remove the blocks where the image data A2 through A4 are displayed from the display screen. This means that the control unit 70 retains the block in which the image data A1, among the sets of image data A1 through A4 belonging to category A, are displayed and removes the blocks in which the other image data are displayed from the display screen. The control unit 70 also adds three new blocks, in which image data B2, B3 and B4 related to the image data B1 having been touched are to be displayed at the display screen. The block to remain on display may be a block where a set of image data other than the image data A1, among the image data A1 through A4 belonging to category A, is displayed. For instance, the block in which the image data A2 are displayed may be left on display with the blocks in which the image data A1, A3 and A4 are displayed removed from the display screen.

It is to be noted that in response to a viewer operation performed by touching the image data B1 at the display screen shown in FIG. 25(d), the control unit 70 may switch from the display screen 730d to a display screen 730k shown in FIG. 26(d) instead. Namely, the control unit 70 may remove the blocks in which the image data A1 through A4 are displayed from the display screen and add new blocks, in which image data B2, B3, B4 and B5 related to the image data B1 having been touched are to be displayed, at the display screen.

It is to be noted that in response to a viewer operation performed by touching the image data B1 at the display screen shown in FIG. 25(d), the control unit 70 may switch from the display screen 730d to a display screen 7301 shown in FIG. 26(e) instead. Namely, the control unit 70 may remove the blocks in which the image data A2 through A4 are displayed from the display screen. This means that the control unit 70 retains the block in which the image data A1, among the sets of image data A1 through A4 belonging to category A, are displayed and removes the blocks in which the other image data are displayed from the display screen. The control unit 70 also adds four new blocks, in which image data B2, B3 and B4 related to the image data B1 having been touched and a new set of image data F1 are to be displayed, at the display screen. The new image data F1 belong to a category different from those to which the image data A1, B1, C1, D1 and E1, having been up on display, belong. The block to remain on display may be a block where a set of image data other than the image data A1, among the image data A1 through A4, is displayed. For instance, the block in which the image data A2 are displayed may be left on display with the blocks in which the image data A1, A3 and A4 are displayed removed from the display screen.

It is to be noted that in response to a viewer operation performed by touching the image data B1 at the display screen shown in FIG. 25(d), the control unit 70 may switch from the display screen 730d to a display screen 730m shown in FIG. 26(f) instead. Namely, the control unit 70 may remove the blocks in which the image data A1 through A4 are displayed from the display screen and adds four new blocks, in which image data B2, B3 and B4 related to the image data B1 having been touched and a new set of image data F1 are to be displayed, at the display screen. The new image data F1 belong to a category different from those to which the image data A1, B1, C1, D1 and E1, having been up on display, belong.

Operations that may be performed in the area 731, examples of which are presented in FIGS. 25(b) and 25(c), will be explained next. The image data displayed in the individual blocks set within the area 731 may be switched freely by the viewer in response to, for instance, an upward or downward flick operation performed by the viewer. For instance, the viewer may flick the area 731 downward toward the bottom of the screen while the display screen 730b in FIG. 25(b) is up, and in response, the control unit 70 switches the display screen 730b to a display screen 730n shown in FIG. 27(a). Namely, the control unit 70 replaces the image data A2 through A5 (image data all related to the image data A1) displayed in the area 731 with other sets of related image data A6 through A9.

In addition, the area 731 may be used to display another set of image data in the block where the image data A1 are displayed. For instance, the viewer may touch the image data A1 at the display screen 730a shown in FIG. 25(a) with two fingers and in response, the control unit 70 may switch from the display screen 730a to a display screen 730o shown in FIG. 27(b). While the display screen 730o appears similar to the display screen 730b in FIG. 25(b), it is distinguishable from the display screen 730b in that a specific block 732 within the area 731 is displayed in a mode different from the display mode for the other blocks in the area 731. Such a block 732 may, for example, be enclosed within a special frame or may be displayed in a color different from the display color for the other blocks.

As the viewer, holding down on the image data A1 with one finger, flicks the area 731 upward or downward with another finger, the control unit 70 scrolls image data displayed in the individual blocks within the area 731. For instance, the viewer may perform an upward flick operation at the area 731 while the display screen 730o in FIG. 27(b) is up, and in response, the control unit 70 may switch from the display screen 730o to a display screen 730p shown in FIG. 27(c). The image data displayed in the individual blocks within the area 731 at the display screen 730p are scrolled up by one set relative to the image data up on display at the display screen 730o. For instance, the image data A2 are displayed in the block 732 and the image data A3 are displayed in the block directly below the block 732 at the display screen 730o shown in FIG. 27(b). At the display screen 730p shown in FIG. 27(c), the image data A3 are displayed in the block 732 with the image data A4 displayed in the block directly below the block 732.

As the viewer lifts his finger, which has been in contact with the image data A1, from the screen while the image data A3 are on display in the special block 732, the control unit 70 switches the image data A1 and the image data A3. FIG. 27(d) shows a display screen 730q that will come up once the switchover has occurred.

As described above, the image data displayed within a block can be replaced with another set of image data related to the image data and as a result, the viewer is able to customize the display screen as desired.

Furthermore, the viewer may be allowed to designate a display screen in a specific state as a default display screen. For instance, the viewer, having customized the block arrangement, the number of blocks, the image data to be displayed in the blocks and the like to his liking, may perform a predetermined operation (e.g., pressing a button (not shown)) and in response, the control unit 70 may store information indicating the block arrangement, the number of blocks, the image data to be displayed in the blocks and the like. The control unit 70 will then use the stored information to restore the display screen with blocks set in the arrangement and in the number indicated in the stored information with image data displayed in the block as indicated in the stored information when the next session of reproduction of the electronic album data 32 starts.

In the embodiments and variations thereof described above, in which new related image data are brought up on display, a message indicating that no more related image data are available may be displayed when all the related image data have been displayed. In addition, if there are still related image data yet to be displayed, an icon indicating that there are related image data still available may be brought up on display at the display screen. Furthermore, a mode other than an icon or the like may be used to indicate that there are still related image data available. For instance, while related image data A2, A3 and A4 belonging to category A are up on display, there may still be related image data A5, A6, A7 and the like belonging to category A that are yet to be brought up on display. Under such circumstances, the related image data A5, A6, A7 and the like may be displayed in sequence over predetermined cycles within the block where the related image data A4 are displayed, so as to indicate that these related image data have not yet been displayed.

The relationship between sets of image data displayed in a plurality of blocks, which are related to one another, may be indicated to the viewer as well. For instance, blocks in which sets of image data belonging to a given category are displayed may be enclosed with same-color frames or an icon corresponding to the category to which the image data displayed in a block belong may be superimposed at a predetermined position (e.g., at an upper right corner) within the block.

The term “image data” used in the description above refers to any type of data that can be displayed, which is not limited to photographic images (still images and video clips) obtained via, for instance, a camera. For instance, text data, formatted document data, data such as slide data to be used for a presentation, or the like may be handled as the image data described above.

An example in which slide data are displayed will be described next. The control unit 70 displays title pages (or table of content pages) of, for instance, four sets of slide data in four blocks. As the viewer touches one of the blocks, the control unit 70 brings up on display the individual pages of the set of slide data corresponding to the particular block among the various blocks. In other words, the pages within a single set of slide data can be handled as related image data belonging to a common category. Through these measures, the content of numerous sets of slide data can be checked at once.

In addition, in correspondence to the force with which a block is touched or the length of time over which a finger remains in touch with a block, the number of pages in the slide data corresponding to the particular block, which are to be displayed in the various blocks, may be adjusted. For instance, when the block is touched with more force or over a longer period of time, a greater number of pages may be added for display.

An example in which text data are displayed will be described. The control unit 70 displays, for instance, four sentences, extracted from four sets of text data, in four blocks. As the viewer touches one of the blocks, the control unit 70 displays the individual sentences, which are included in the text data corresponding to the particular block, in the various blocks.

In addition, text data and image data may be displayed in combination. For instance, a photograph (image data) captured at a wedding and a message from the photographer (text data) may be stored in correlation to each other within electronic album data 32. In such a case, the control unit 70 displaying the image data in a given block displays the text data corresponding to the image data in another block by pairing them together. Moreover, a date may be displayed in a given block and photographs (image data) captured on the particular date may be displayed in other blocks. In this application, the viewer is able to adjust the date by touching the block where the date is on display. As the viewer alters the date, the control unit 70 replaces the image data displayed in the other blocks with image data obtained on the new date.

An example of video image data reproduction will be explained next. Video image data A1 and still image data C1, D1 and E1 are displayed at a display screen 730r shown in FIG. 28(a). In the initial state, the video image data A1 are paused (not playing). As the viewer touches the video image data A1 (as the viewer touches the block in which the video image data A1 are on display), the control unit 70 starts playing back the video image data A1. In other words, the video image data A1 enter a playback-in-progress state.

As the viewer touches the video image data A1 while the video image data A1 are being played back, the control unit 70 displays a reproduced frame B1 in the video image data A1, which is being played at the time at which the video image data A1 are touched, in a block other than the block in which the video image data A1 are displayed. For instance, the control unit 70 may add a new block such as that in a display screen 730s shown in FIG. 28(b) and display the reproduced frame B1 in the video image data A1 in the new block.

Once the playback of the video image data A1 has been completed, the control unit 70 starts playing back video image data A2, A3 or the like related to the video image data A1 within the same block. While such related video image data are being played back, the reproduced frame B1 mentioned earlier stays on display at the display screen, an example of which is a display screen 730t shown in FIG. 2(c). As the viewer touches the video image data A3 being played back, the control unit 70 displays a reproduction frame B3 in the video image data A3, which is being played at the point in time at which the video image data A3 are touched, in a block other than the block in which the video image data A3 are displayed, in much the same way as that described earlier. For instance, the control unit 70 may add a new block such as that in a display screen 730u shown in FIG. 28(d) and display the reproduction frame B3 in the video image data A3 in the new block.

There are cameras known in the related art capable of shooting a video clip and a still image at the same time. For instance, a camera in the known art is capable of capturing a still image while continuously shooting moving images in response to a predetermined operation performed while video shooting is in progress or if a specific subject is detected while video shooting is in progress. A pair of a video clip and a still image obtained via such a camera may be displayed in a mode different from that applied to regular video clips and still images.

### Sixth Embodiment

The following is a description of the sixth embodiment. It is to be noted that the same reference symbols are assigned to components identical to those in the first embodiment described earlier so as to preclude the necessity for a repeated explanation thereof.

FIG. 16 schematically illustrates data stored in the storage device 30. A plurality of sets of image data 31 and a plurality of sets of electronic album data 32 are stored in the storage device 30. The image data 31 are image files created in the camera 5 in, for instance, the JPEG format. Each set of image data 31 in the embodiment is an image file with a still image recorded therein.

A set of electronic album data 32 expresses an electronic album. A plurality of sets of image data 31 are correlated to a set of electronic album data 32. The user is able to create and edit electronic album data 32 by, for instance, operating the information terminal 4. The user selects a plurality of sets of image data 31 and creates a set of electronic album data 32 to which the selected image data 31 are correlated. In the following description, image data 31 correlated to a set of electronic album data 31 will be referred to as image data 31 included in the particular set of electronic album data 32.

FIG. 17 is a block diagram schematically illustrating the structure of a portable device 7. In the flash memory 72, schedule data 720 are stored in addition to the control program and the like explained earlier. The schedule data 720 are data pertaining to the daily schedule of the user of the portable device 7. The user of the portable device 7 is able to display and edit the schedule data 720 by using a program known as a scheduling program.

FIG. 18 schematically illustrates the structure of the schedule data 720. The schedule data 720 include a plurality of sets of data, each indicating a date 7201, a time block 7202, and a scheduled event 7203. Additional information such as a location, means of transportation and the like may be recorded as well. Each set of schedule data indicates a single scheduled event pertaining to the user. For instance, a set of schedule data 720a in FIG. 18 indicates that the user has a “meeting A” scheduled between 10 a.m. and 11 a.m. on October 15. The portable device 7 is capable of executing a program referred to as a scheduling program that displays the user's schedule, together with a calendar, based upon the schedule data 720. The user operates this program to edit the schedule data. Since such a program is of the known art, its explanation is not provided.

The portable device 7 is capable of reproducing an electronic album based upon electronic album data 32 stored in the storage device 30. The user of the portable device 7 enters an instruction specifying a set of electronic album data 32 he wishes to reproduce, among the sets of electronic album data 32 stored in the storage device 30, at the portable device 7. The portable device 7 receives the specified electronic album data 32 from the server 3 and executes electronic album reproduction processing. The reproduction processing executed to reproduce an electronic album will be explained next.

FIG. 19(a) presents an example of a display screen 73a that may come up for electronic album reproduction and FIG. 19(b) presents an example of a display screen 73b different from the display screen 73a in FIG. 19(a). The display screen 73a in FIG. 19(a) is partitioned in a tile pattern into a first block 100a, a second block 100b, a third block 100c and a fourth block 100d. In the following description, individual blocks such as the first block 100a the second block 100b, the third block 100c and the fourth block 100d may be generically referred to as a block 100. The individual blocks 100 each take a rectangular shape, but their sizes and positions vary. It is to be noted that the blocks 100 do not need to take a rectangular shape and may instead take another shape such as a square shape or a rhomboid shape.

The display screen 73b in FIG. 19(b) is distinguishable from the display screen 73a in FIG. 19(a) in that it includes additional blocks, i.e., a fifth block 100e and a sixth block 100f. The control unit 70 compresses the second block 100b, the third block 100c and the fourth block 100d, i.e., the existing blocks 100 other than the first block 100a, so as to secure a sufficient display area to accommodate the fifth block 100e and the sixth block 100f. In other words, the control unit 70 alters the number of the plurality of blocks 100, their shapes, their positions and their sizes at the display screen 73b in FIG. 19(b) from those at the display screen 73a in FIG. 19(a).

The control unit 70 executing the electronic album reproduction processing selectively uses either the display screen 73a in FIG. 19(a) or the display screen 73b in FIG. 19(b) based upon the schedule data 720. The following is an explanation of a method through which the display screen is selected based upon the schedule data 720.

The display device is equipped with sensors for identifying the viewer through face recognition with an image capturing device, fingerprint authentication, voice recognition or the like. The display device is able to identify the viewer via these sensors.

When reproducing an electronic album, the control unit 70 reads out the schedule data 720 to check the viewer's schedule for the day. The viewer's schedule may be read out by, for instance, obtaining the schedule data pertaining to the viewer, saved in a cloud, via wireless communication. As an alternative, schedule data pertaining to the viewer may be saved in a device (e.g., a portable device such as a smart phone with schedule management software) associated with the display device and in such a case, once the control unit at the display device has identified the viewer as described above, the viewer's schedule may be read out from the associated device. The control unit 70 extracts scheduled events for a date 7201 (see FIG. 18) matching the current date from the schedule data 720. The control unit 70 calculates the length of a time block that is not included in the time blocks 7202 for the extracted scheduled events within the time range 0 o'clock through 24 o'clock, i.e., it ascertains a time block (free time block) during which no event is scheduled. The control unit 70 reproduces the electronic album at the display screen 73b shown in FIG. 19(b) if the duration of the free time block is less than a predetermined time length. If, on the other hand, the duration of the free time block is equal to or greater than the predetermined time length, the control unit 70 reproduces the electronic album at the display screen 73a shown in FIG. 19(a). Namely, if the viewer's schedule is tight by an extent equal to or greater than a predetermined degree, the control unit 70 displays a greater number of blocks 100 than those displayed when the viewer's schedule is not as tight as the predetermined degree.

When reproducing the electronic album by using the display screen 73a in FIG. 19(a), the control unit 70 selects four sets of image data 31a, 31b, 31c and 31d among the sets of image data 31 included in the reproduction-target electronic album data 32 and displays them respectively in the first block 100a, the second block 100b, the third block 100c and the fourth block 100d. It is to be noted that the sizes and aspect ratios of the sets of image data 31a through 31d do not necessarily match the sizes and aspect ratios of the corresponding blocks 100. The control unit 70 processes the image data 31a through 31d as needed so that they can be fitted into the corresponding blocks 100 on display. For instance, the image data 31a to be displayed in the first block 100a may be enlarged or reduced, part of the image data 31a may be cropped or the aspect ratio of the image data 31a may be adjusted by creating a margin around the image data 31a.

The viewer is able to navigate through pages, e.g., move forward or backward among pages by touching the touch panel 74 or by operating an operation member (not shown). In response to a page navigating operation performed by the viewer, the control unit 70 may replace the image data currently displayed in the various blocks 100a through 100d with other sets of image data 31 while sustaining the current display mode for the plurality of blocks 100.

In addition, instead of switching pages on display at the display screen in response to a page navigating operation performed by the viewer, pages may be automatically switched when a predetermined length of time (e.g., five seconds) elapses after the viewer is identified via a sensor capable of identifying the viewer, included at the display device (e.g., an image capturing device capable of face recognition). As an alternative, pages may be switched in response to a voice instruction issued by the viewer or in response to a viewer operation performed to select one image among the plurality of images on display.

It is to be noted that it is not strictly necessary to make all the sets of image data 31 included in the electronic album available for viewing in response to a page navigating operation. In addition, sets of image data 31 to be newly brought up on display in response to a page navigating operation may be determined based upon predetermined priority rankings. Such priority rankings may be determined for numerous sets of image data 31 included in each electronic album through an existing image determination method such as subject extraction and vertical/horizontal composition.

The control unit 70, reproducing the electronic album at the display screen 73b shown in FIG. 19(b), selects six sets of image data 31a, 31b, 31c, 31d, 31e and 31f among the sets of image data 31 included in the reproduction-target electronic album data 32 and displays them in the first block 100a, the second block 100b, the third block 100c, the fourth block 100d, the fifth block 100e and the sixth block 100f respectively. Since a greater number of sets of image data 31 can be brought up on display on a single page, compared to the number of sets of image data that can be displayed at the display screen 73a in FIG. 19(a), faster and more desirable reproduction processing can be executed for the busy viewer with limited free time.

It is to be noted that while the display screen 73a in FIG. 19(a) and the display screen 73b in FIG. 19(b) are selectively used in the explanation provided above, a given display screen among a greater number of display screens may be selected in correspondence to the duration of the free time block. For instance, 10 different display screens, each having blocks 100 set therein in a quantity different from the rest, may be created in advance and a display screen among the 10 different display screens may be selected in correspondence to the duration of the free time block falling into a specific range among the 10 different time length ranges.

FIG. 20 presents a flowchart of the reproduction processing. In step S10, an instruction for identifying electronic album data 32 to be designated as a reproduction target is input to the control unit 70. The viewer enters, via an input device such as the touch panel 74, the title, the URL or the like of a specific electronic album, required for identification of the particular electronic album data 32. In step S20, the control unit 70 receives the reproduction-target electronic album data 32 from the server 3.

In step S30, the control unit 70 reads out the schedule data 720, collects scheduled events for the viewer on the day and calculates the duration of the free time block the viewer has for the day. In step S40, the control unit 70 makes a decision as to whether or not the length of the free time block is equal to or greater than the predetermined time length. If the duration of the free time block extends over the predetermined time length or more, the control unit 70 proceeds to execute the processing in step S50. In step S50, the control unit 70 selects the display screen 73a, such as that shown in FIG. 19(a), with fewer blocks 100, and then proceeds to execute the processing in step S70. If, on the other hand, it is decided in step S40 that the duration of the free time block is less than the predetermined time length, the control unit 70 proceeds to execute the processing in step S60. In step S60, the control unit 70 selects the display screen 73b, such as that shown in FIG. 19(b), with more blocks 100, and then proceeds to execute the processing in step S70.

In step S70, the control unit 70 selects four sets of image data 31 or six sets of image data 31 to be brought up on display at the display screen, among the sets of image data 31 included in the electronic album data 32. In step S80, the control unit 70 displays the four sets of image data 31 or the six sets of image data 31 having been selected in step

S70 in the four blocks 100a through 100d such as those in FIG. 19(a) or in the six blocks 100a through 100f, such as those shown in FIG. 19(b).

In step S90, the control unit 70 makes a decision as to whether or not a specific page navigating operation has been input. If no page navigating operation has been input, the control unit 70 proceeds to execute the processing in step S120. If, on the other hand, a page navigating operation has been input, the control unit 70 proceeds to execute the processing in step S100.

In step S100, the control unit 70 selects image data 31 different from the currently selected image data 31. In step S110, the control unit 70 updates the screen display so as to bring up on display the newly selected image data 31 in the blocks 100. In step S120, the control unit 70 makes a decision as to whether or not a predefined reproduction end operation has been performed. If no reproduction end operation has been performed, the control unit 70 proceeds to execute the processing in step S90. If, on the other hand, a reproduction end operation has been performed, the control unit 70 ends the electronic album reproduction processing.

The following advantages and operations are achieved through the embodiment described above.

(1) The control unit 70 individually displays a plurality of sets of image data 31 having been selected in a plurality of blocks 100 displayed in a display mode determined based upon schedule data 720, which are a type of user information pertaining to attributes of the user viewing images. As a result, a display device assuring ease of use, at which an optimal screen is brought up on display without requiring a complicated operation, can be provided.

(2) The control unit 70 determines the number of the plurality of blocks 100, their shapes, their positions and their sizes based upon user information. Thus, an electronic album can be reproduced in an optimal display mode best suited to the particular user.

(3) The user information used in the embodiment is the schedule data 720 pertaining to the schedule of the user for at least the day of image viewing. Thus, an electronic album can be reproduced in an optimal display mode best suited to the user's schedule.

(4) If the schedule is tight by an extent equal to or exceeding a predetermined degree, the control unit 70 displays a greater number of blocks 100 compared to the number of blocks displayed when the schedule is not as tight as the predetermined degree. Through these measures, the display screen 73b that allows the busy user to view more images at a glance can be provided, whereas the display screen 73a at which individual images are displayed over greater areas can be provided for the user with more free time.

It is to be noted that while a greater number of sets of image data 31 are brought up on display at a single display screen 73 for a busy viewer with less free time so as to allow him to quickly view more images in the explanation provided above, there may be a viewer who wishes to view image data 31 displayed in a display size equal to or greater than a predetermined size at the display screen 73. In such a case, the image data 31 to be brought up on display at the display screen 73 may be displayed at a display size chosen by the viewer.

In addition, instead of displaying a greater number of sets of image data 31 at the display screen 73 for a busy viewer, sets of image data each representing one of a plurality of categories may be brought up on display at the display screen by correlating the image data to specific categories (e.g., travel, sporting event, landscape and the like). Such a display will allow a busy viewer to find images he wishes to view with better ease.

It is to be noted that while an explanation has been given above on an example in which blocks are set for images to be displayed at the display screen 73 and image data 31 are reproduced based upon the viewer's schedule, the viewer may be judged to have time to spare if he looks at an image for a long time. If, on the other hand, the viewer quickly scans an image, it may be judged that the viewer does not have much time and is in a hurry. The length of time over which the viewer views an image can be determined by detecting the line of sight of the viewer.

### Seventh Embodiment

The image reproduction system achieved in the seventh embodiment determines the display mode for the blocks 100 based upon user information (information pertaining to the user's preferences) different from the schedule data 720 having been explained in reference to the sixth embodiment. The following is an explanation of features distinguishing the image reproduction system achieved in the seventh embodiment from the image reproduction system achieved in the sixth embodiment, given in reference to FIGS. 21 and 22. It is to be noted that components identical to those in the sixth embodiment are assigned with the same reference signs so as to preclude the necessity for a repeated explanation thereof.

FIG. 2 schematically illustrates data stored in the storage device 30. In the seventh embodiment, at least one set of category data 33, indicating a category determined based upon image content, is correlated to each set of image data 31, as in the first embodiment and the like.

FIG. 21 is a block diagram schematically illustrating the structure of a portable device 7. Preference data 721 are stored in the flash memory 72 of the portable device 7 achieved in the seventh embodiment. The preference data 721 relate to the preferences of the user (viewer) who uses the portable device 7. The preference data 721 in the seventh embodiment indicate viewer preferences pertaining to the screen layout and pertaining to categories of the image data 31. The preferences pertaining to the screen layout may indicate, for instance, “the user prefers four blocks the most”, “the user prefers blocks 100 in sizes no smaller than 100 pixels by 80 pixels” and the like. Preferences pertaining to the categories of the image data 31 may indicate, for instance, “the viewer prefers image data belonging to the category “automobile” the most”, “the viewer does not prefer image data belonging to the “nighttime” category” and the like.

It is to be noted that the preference data 721 may be created based upon preferences directly entered by the viewer himself, or they may be created through another method. For instance, the viewer may enter information indicating whether he likes or dislikes a given screen layout while a display screen with the particular screen layout is up on display and the information thus entered may be reflected in the preference data 721. In addition, information indicating whether or not the viewer likes a given screen layout or category, entered with a program or the like completely separate from the electronic album reproduction program may also be reflected in the preference data 721.

The control unit 70, executing electronic album reproduction, determines a display mode to be taken for the plurality of blocks 100 to be brought up on display at the screen and image data 31 to be displayed based upon viewer preferences indicated in the preference data 721. The following is a detailed explanation of this feature.

FIG. 22(a) presents an example of a display screen 73c that may come up for electronic album reproduction. The display screen 73c is partitioned in a tile pattern into a first block 100a, a second block 100b, a third block 100c, a fourth block 100d, a fifth block 100e and a sixth block 100f. Unless a specific preference of the viewer is indicated in the preference data 721, the control unit 70 displays image data A1, B1, C1, D1, E1 and F1 individually in the first block 100a through the sixth block 100f. It is to be noted that although a repeated explanation is not provided, the viewer is able to navigate through the pages by performing a page navigating operation similar to that described earlier in reference to the first embodiment.

The image data A1, B1, C1, D1, E1 and F1 respectively belong to categories A, B, C, D, E and F which are different from one another. Namely, the control unit 70 brings up on display six different types of image data A1 through F1 belonging to categories A through F different from one another at a single display screen 73c.

FIG. 22(b) presents an example of a display screen 73d reflecting viewer preferences pertaining to categories. The preference data 721 may indicate, for instance, that the viewer likes category A more and likes category D less. In such a case, the control unit 70 displays a greater number of sets of image data 31 belonging to category A and displays less image data 31 belonging to category D. The display screen in FIG. 22(b) differs from the display screen shown FIG. 22(a) in that the image data D1 belonging to category D are no longer on display. In addition, image data A2 and A3 belonging to category A are displayed in addition to the image data A1 belonging to category A. It is to be noted that the image data C1 belonging to category C are also taken off the display at the display screen in FIG. 22(b), in order to make room for the image data A2 and A3 belonging to the preferred category A to be brought up on display with priority.

FIG. 22(c) presents an example of a display screen 73e reflecting viewer preferences pertaining to the screen layout. The preference data 721 may indicate, for instance, that the viewer likes a screen with four blocks 100 on display. In such a case, the control unit 70 sets the number of blocks 100 to be brought up on the screen at four. The display screen in FIG. 22(c) differs from that in FIG. 22(a) in that the fifth block 100e and the sixth block 100f are taken out of the screen and as a result, a total of four blocks 100, i.e., the first block 100a through the fourth block 100d, are displayed at the screen.

The following advantages and operations are achieved through the embodiment described above.

(5) The control unit 70 displays a plurality of sets of image data 31 having been selected in a plurality of blocks 100 set at the display screen by applying a display mode determined based upon the preference data 721, which are user information pertaining to attributes of the user viewing the images. As a result, a display device assuring ease of use, at which an optimal screen is brought up on display without requiring a complicated operation, can be provided.

(6) The control unit 70 determines the number of the plurality of blocks 100, their shapes, their positions and their sizes based upon user information. Thus, an electronic album can be reproduced in an optimal display mode best suited to the particular user.

(7) The preference data 721 indicating user preferences pertaining to the display mode for blocks 100 are used as the user information. Thus, an electronic album can be reproduced in an optimal display mode best suited to the user's preferences.

### Eighth Embodiment

The image reproduction system achieved in the eighth embodiment determines a display mode for blocks 100 based upon user information (information pertaining to the visual acuity of the user) different from the schedule data 720 explained in reference to the sixth embodiment and the display capability of the liquid crystal display unit 73. The following is an explanation of features distinguishing the image reproduction system achieved in the eighth embodiment from the image reproduction system achieved in the sixth embodiment, given in reference to FIG. 23. It is to be noted that components identical to those in the sixth embodiment are assigned with the same reference signs so as to preclude the necessity for a repeated explanation thereof.

FIG. 23 is a block diagram schematically illustrating the structure of a portable device 7. The portable device 7 in the eighth embodiment further includes an image capturing unit 76, in addition to various units similar to those in the portable device 7 in the sixth embodiment. The image capturing unit 76 is disposed at the surface where the display surface of the liquid crystal display unit 73 is located. The image capturing unit 76, which may include, for instance, an image capturing optical system and an image sensor, is configured so that an image of at least the face of the user (viewer) using the portable device 7 can be captured.

In the flash memory 72 in the portable device 7 achieved in the eighth embodiment, visual acuity data 722 and display capability data 723 are stored. The visual acuity data 722 are data related to the visual acuity of the user (viewer) who uses the portable device 7. The control unit 70 estimates the visual acuity of the user based upon an image of the viewer's face captured via the image capturing unit 76. It estimates, for instance, the age of the viewer by detecting characteristic quantities representing predetermined characteristics in the image of the viewer's face and selects an estimated visual acuity level for the viewer, which is set in advance in correspondence to the particular age. It is to be noted that the visual acuity of the viewer may be detected through a method different from that described above. In addition, the viewer may directly enter data indicating his visual acuity and the data thus entered may be used as the visual acuity data 722. The display capability data 723 are data related to the display capability of the liquid crystal display unit 73. The display capability of the liquid crystal display unit 73 is indicated by the screen size of the liquid crystal display unit 73 and the number of display pixels (resolution) at the liquid crystal display unit 73.

The control unit 70 reproducing an electronic album, determines a display mode in which the plurality of blocks 100 are to be displayed at the screen based upon the visual acuity data 722 and the display capability data 723. In more specific terms, it increases the number of blocks 100 so that more blocks 100, having smaller sizes, are brought up on display at the screen (e.g., the display screen 73a in FIG. 19(a)) if the visual acuity of the viewer is higher. It reduces the number of blocks 100 so that fewer blocks 100, having greater sizes, are brought up on display at the screen (e.g., the display screen 73b in FIG. 19(b)) if the visual acuity of the viewer is lower. In addition, the control unit 70 increases the number of blocks 100 to be brought up on display at the screen if the size of the screen at the liquid crystal display unit 73 is greater and reduces the number of blocks 100 to be brought up on display at the screen if the screen size is smaller. The control unit 70 reduces the number of blocks 100 to be brought up on display at the screen if the number of display pixels at the liquid crystal display unit 73 is greater, whereas it increases the number of blocks 100 to be brought up on display at the screen if the number of display pixels is smaller.

The following advantages and operations are achieved through the embodiment described above.

(8) The control unit 70 displays a plurality of sets of image data 31 having been selected in a plurality of blocks 100 set at the display screen by applying a display mode determined based upon the visual acuity data 722, which are user information pertaining to attributes of the user viewing the images. As a result, a display device assuring ease of use, at which an optimal screen is brought up on display without requiring a complicated operation, can be provided.

(9) The control unit 70 determines the number of the plurality of blocks 100, their shapes, their positions and their sizes based upon user information. Thus, the electronic album can be reproduced in an optimal display mode best suited to the particular user.

(10) The visual acuity data 722 pertaining to the user's visual acuity are used as the user information. Thus, an electronic album can be reproduced in an optimal display mode best suited to the user's visual acuity.

(11) The control unit 70 displays a greater number of blocks 100 if the user's visual acuity is equal to or higher than a predetermined level compared to the number of blocks 100 brought up on display when the user's visual acuity is lower than the predetermined level. Thus, an electronic album can be reproduced in an optimal display mode best suited to the user's visual acuity.

(12) The control unit 70 executes control so that information pertaining to visual acuity is detected based upon the results obtained by capturing an image of at least part of the user's face via the image capturing unit 76. Thus, an image reproduction system assuring ease of use, which does not require the user to enter information pertaining to his visual acuity, can be provided.

(13) The control unit 70 determines a display mode for the blocks 100 based upon the size of the display screen and the resolution (the number of display pixels) in addition to the user information. Through these measures, an image reproduction system assuring even better ease of use, which displays image data 31 by also taking into consideration the display capability of the portable device 7, can be provided.

### Ninth Embodiment

The image reproduction system achieved in the ninth embodiment determines a display mode for the blocks 100 based upon the relationship between the user viewing images and the image data 31. The following is an explanation of features distinguishing the image reproduction system achieved in the ninth embodiment from the image reproduction system achieved in the sixth embodiment, given in reference to FIG. 24. It is to be noted that components identical to those in the sixth embodiment are assigned with the same reference signs so as to preclude the necessity for a repeated explanation thereof.

FIG. 24 schematically illustrates data stored in the storage device 30. Related user data 34 are correlated to image data 31 in the ninth embodiment. Each set of related user data 34 carries information indicating at least one user related to the corresponding set of image data 31. For instance, a user Y may have been with a user X during a specific time block while the user X was on a trip. In such a case, related user data 34 indicating both the user X and the user Y are set in correlation to any set of image data obtained during the particular time block on the trip.

If an electronic album includes any image data 31 to which related user data 34 indicating the viewer are correlated, the control unit 70 reproduces the image data 31 (related image data) with priority. It may, for instance, simply reproduce the image data 31 alone without reproducing any other image data 31 (unrelated image data). If, on the other hand, the electronic album does not include any image data 31 to which related user data 34 indicating the viewer are set in correlation, the control unit 70 reproduces, with priority, image data 31 (unrelated image data) to which related user data 34 indicating users other than the creator of the electronic album are not set in correlation. It may, for instance, simply reproduce such image data 31 alone without reproducing any image data 31 to which related user data 34 indicating users other than the creator of the electronic album are set in correlation.

The following advantages and operations are achieved through the embodiment described above.

(14) A plurality of sets of image data 31 include related image data related to the user and unrelated image data 31 that are not related to the user. The control unit 70 sets a plurality of blocks 100 in a display mode determined based upon the related image data when images are being viewed by the user. As a result, a display device assuring ease of use, at which an optimal screen is brought up on display without requiring a complicated operation, can be provided.

(15) When the user is viewing images, the control unit 70 displays the related image data among the plurality of sets of image data 31 in the plurality of blocks 100, whereas when another user is viewing images, it displays unrelated image data among the plurality of sets of image data 31 in the plurality of blocks 100. Through these measures, optimal image data 31 can be brought up on display for each user that views images.

One of or a plurality of the following variations may be adopted in combination with any of the sixth through ninth embodiments described above.

### (Variation 1)

The image data 31 may be video clips (or moving images) instead of still images. In such a case, a plurality of sets of image data 31 (video clips) may be designated to a single block 100. The control unit 70 plays back a plurality of sets of image data 31 (video clips) designated to the block 100 in sequence. Namely, it plays back the plurality of sets of image data 31 (video clips) in the block 100 through time-apportioned play.

In addition, instead of playing back the plurality of video clips in their entirety in the single block 100, part of each video clip may be extracted and played back. For instance, four video clips assigned to a single block 100 may each be played back over a limited playback time of one minute. In addition, instead of determining a uniform playback time for the plurality of video clips, the playback time for each video clip may be determined based upon the various types of user information described earlier. For instance, a video clip belonging to a category preferred by the user may be allocated with a longer playback time compared to other video clips.

### (Variation 2)

In the embodiments described earlier, the portable device 7 is operated by performing touch operations at the touch panel 74. In other words, instructions issued by the viewer are invariably input to the control unit 70 through touch operations performed at the touch panel 74. Instead of such touch operations, the viewer may perform operations at another operation member (e.g., a mechanical switch).

In addition, touch operations may be replaced with predetermined movements of the viewer detected by various types of sensors. For instance, the viewer's line of sight may be detected by an image capturing device and a change in the sight line may be used as an instruction issued by the viewer. As an alternative, a hand gesture made by the viewer may be detected via an infrared sensor or the like and a predetermined hand gesture may be regarded as an instruction. Moreover, the voice of the viewer may be detected through a microphone and a predetermined sound may be regarded an instruction.

### (Variation 3)

While the portable device 7 described in reference to the various embodiments above is a mobile terminal such as a tablet terminal or a smart phone, the present invention may be adopted in conjunction with a terminal having another form. For instance, the present invention may be adopted in a display device with a display screen, such as a desktop personal computer or a large-screen monitor installed at a fixed location. When the portable device 7 in the various embodiments or another display device is configured as any of various terminals with varying screen sizes, the number of blocks 100 may be adjusted in correspondence to the screen size of a specific terminal.

### (Variation 4)

The operating methods and display methods described above simply represent examples and the present invention may adopt an operating method or display method different from those. For instance, the entire display screen is covered with a plurality of blocks 100 in the embodiments described above. As an alternative, clearances may be provided between the individual blocks 100. Namely, the plurality of blocks 100 do not need to be densely set without any gaps between them over the entire display screen. In another example related to a display method, a display device such as that disclosed in International Publication WO 2013/077338, that displays a 3D image in space may be used in place of the liquid crystal display unit 73.

### (Variation 5)

The electronic album data 32 may include information indicating a layout for the individual sets of image data 31 included in each electronic album, as well as the information used to identify the individual sets of image data 31 in the electronic album.

In such a case, a person creating an electronic album compiles it by including information indicating a screen layout for reproduction (i.e., a display mode for the plurality of blocks 100). It is desirable that the control unit 70 reproduces the electronic album by using the screen layout set by the creator of the electronic album as much as possible. For instance, when increasing the number of blocks 100 based upon the user information, it may add blocks 100 by splitting a specific block 100 instead of adding blocks 100 by altering the sizes or the positions of numerous blocks 100.

### (Other Variations)

The results obtained by identifying the viewer may be used for purposes other than schedule data readout. For instance, a first viewer may hand the portable device 7 to a second viewer while a set of electronic album data 32 is being reproduced. At this time, the control unit 70 identifies the second viewer and detects that a switch has occurred from the first viewer to the second viewer. Subsequently, the second viewer, having viewed image data, returns the portable device 7 to the first viewer. The control unit 70 then detects that the second viewer has returned the portable device to the first viewer by identifying the viewer. The control unit 70 accordingly resumes the last display screen that was up when the first viewer was viewing images. As an alternative, it may bring up on display information indicating the operation having been performed by the second viewer and the image data brought up on display in response to the operation. For instance, the changes that have occurred at the display screen starting at the time point at which the second viewer started viewing images may be reproduced in sequence so that the first viewer can have an image viewing experience similar to that experienced by the second viewer.

In addition, a plurality of viewers (using a plurality of portable devices 7) viewing a single set of electronic album data 32 may be allowed to share viewing information. For instance, a given viewer may flick the entire display screen and in response, the control unit 70 may switch to a display screen being viewed by another viewer (or a display screen that was viewed in the past). As an alternative, a viewer may scroll up or down the column in which the image data A2 through A4, for instance, are currently displayed and, in response, the control unit 70 may bring up on display images (e.g., image data A5 through A7) currently being viewed by another viewer (or images viewed in the past) in the column.

As long as the features characterizing the present invention remain intact, the present invention is not limited to the particulars of the embodiments described above and any other mode conceivable within the scope of the technical teaching of the present invention is within the scope of the present invention.

The embodiments and variations thereof described above include display devices, a display program and a display method described below.

(1) A display device comprises a display unit at which a plurality of images are displayed and a control unit that executes control so that a first display mode or a second display mode is selected for a display mode in which the plurality of images are displayed at the display unit. The first display mode is a display mode which includes a plurality of first areas and a plurality of first images, and the second display mode is a display mode which includes a plurality of second areas and a plurality of second images. At least one of the plurality of second areas has a size different from the sizes of the plurality of first areas or a number of the plurality of second areas is different from the number of the plurality of first areas, and the content of at least one image among the plurality of second images is different from the content of the plurality of the first images. Upon detecting at least either an instruction for image selection issued to select at least one image among the plurality of first images or an instruction for area selection issued to select at least one area among the plurality of first areas, the control unit switches from the first display mode to the second display mode.

(2) In the display device such as that described in (1) above, the control unit displays an image for which the instruction for image selection has been detected, as a detected image in the second display mode.

(3) In the display device such as that described in (1) above, the control unit displays an image, displayed in an area with respect to which the instruction for area selection has been detected, as a detected image in the second display mode.

(4) In the display device such as that described in (2) or (3) above, the control unit displays at least one related image, related to the detected image, in the second display mode.

(5) In the display device such as that described in (4) above, the control unit displays related images by ensuring that the number of related images brought up on display does not exceed a specific value.

(6) In the display device such as that described in (5) above, upon detecting the instruction for image selection or the instruction for area selection after the number of related images brought up on display reaches the specific value, the control unit replaces the oldest image on display at the display unit with an image, among the related images, which has not yet been displayed.

(7) In the display device such as that described in any one of (2) through (6) above, the control unit displays another image among the plurality of first images, different from the detected image, in the second display mode.

(8) In the display device such as that described in (7) above, the control unit displays the other image in the second display mode by setting the areal size of the other image equal to or greater than a predetermined size. Like in (5).

(9) In the display device such as that described in any one of (1) through (8) above, the control unit continuously adjusts the correspondence between the images and the areas based upon the length of time over which at least either the instruction for image selection or the instruction for area selection is detected.

(10) In the display device such as that described in any one of (1) through (9) above, the control unit continuously adjusts the correspondence between the images and the areas based upon the strength of a pressing force via which at least either the instruction for image selection or the instruction for area selection is detected.

(11) In the display device such as that described in (1) above, at least one area among the plurality of first areas is carried over to be included in the plurality of second areas.

(12) In the display device such as that described in (11) above, the area which is carried over as an area switch from the plurality of first areas to the plurality of second areas occurs, is the area specified in the instruction.

(13) In the display device such as that described in (11) or (12) above, if the size of at least one area among the plurality of second areas is different from the sizes of the plurality of first areas, at least one factor among the number of areas, the shapes of the areas and the positions of the areas is also different, or if the number of the plurality of second areas is different from the number of the plurality of first areas, at least one factor among the shapes of the areas, the positions of the areas and the sizes of the areas is also different.

(14) In the display device such as that described in any one of (11) through (13) above, if a specific instruction is issued as a selection instruction for selecting one category among a plurality of categories pertaining to the plurality of first images, the control unit brings up on display, in the second display mode, at least one image different from the plurality of first images, which corresponds to the category specified in the selection instruction.

(15) In the display device such as that described in (14) above, if the specific instruction is a lock instruction for locking at least one display mode included in the first display mode as part thereof, the control unit brings up a display in the second display mode without altering the display mode indicated in the lock instruction.

(16) In the display device such as that described in (14) or (15) above, the specific instruction is issued through at least one of an operation at an operation member and a gesture detected via a predefined detector.

(17) In the display device such as that described in any one of (14) through (16) above, the control unit adjusts both the display mode for the plurality of areas and the plurality of images based upon a history indicating at least one of the length of time over which each image was viewed previously and the number of times each image was viewed previously in addition to the specific instruction.

(18) In the display device such as that described in any one of (1) through (17) above, the plurality of images includes a plurality of video clips, and the display unit designates the plurality of video clips to at least one area among the plurality of areas and plays back the plurality of video clips in the one area through time-apportioned play (or time-division).

(19) In the display device such as that described in any one of (1) through (18) above, if there is an image related to an image on display in at least one area among the plurality of areas, the display unit brings up on display an index indicating the presence of the related image.

(20) In the display device such as that described in (19) above, in response to a specific operation performed while the index is up on display, the control unit switches to a new area and the display unit displays the related image in the new area.

(21) In the display device such as that described in (1) above, the control unit switches the display mode at the display unit from the first display mode to the second display mode based upon viewer information pertaining to a viewer that views images at the display unit and the viewer information is personal information that varies from one individual to another.

(22) In the display device such as that described in (21) above, the viewer information is information related to the environment surrounding the viewer.

(23) In the display device such as that described in (21) above, the personal information is information pertaining to a schedule set for the viewer for at least the day of viewing.

(24) In the display device such as that described in (23) above, if the schedule is tight to an extent equal to or greater than a predetermined degree, the control unit increases the number of the plurality of areas compared to the number of areas displayed when the schedule is not as tight as the predetermined degree.

(25) In the display device such as that described in (21) above, the personal information is information indicating preferences of the viewer pertaining to the display mode.

(26) In the display device such as that described in (21) above, the personal information is information pertaining to the visual acuity of the viewer.

(27) In the display device such as that described in (26) above, if the visual acuity is equal to or higher than a predetermined level, the display unit increases the number of the plurality of areas compared to the number of areas displayed when the visual acuity is not as high as the predetermined level.

(28) The display device such as that described in (26) or (27) above further comprises a detection unit that detects information pertaining to the visual acuity based upon results obtained by capturing an image of at least part of the face of the viewer.

(29) In the display device such as that described in any of (21) through (28) above, the control unit switches the display mode based upon at least one of the size of the display screen at the display unit and the resolution achieved at the display unit in addition to the viewer information.

(30) In the display device such as that described in any one of (21) through (29) above, the plurality of images includes related images related to the viewer and unrelated images that are not related to the viewer, and when the viewer views images, the control unit sets the plurality of areas where images are displayed based upon the related images related to the viewer.

(31) In the display device such as that described in (30) above, when the viewer views images, the control unit displays the related images, among the plurality of images, in the plurality of areas, whereas when another viewer views images, the control unit switches to the unrelated images, among the plurality of images, to be displayed in the plurality of areas.

(32) A display device comprises a display unit at which a plurality of images are displayed and a control unit that executes control so that a first display mode or a second display mode is selected for a display mode in which the plurality of images are displayed at the display unit. The first display mode is a display mode for displaying images in a plurality of first areas, and the second display mode is a display mode for displaying images in a plurality of second areas. At least one of the plurality of second areas has an size different from the sizes of the plurality of first areas or the number of the plurality of second areas is different from the number of the plurality of first areas. Upon detecting an instruction for selecting at least one area among the plurality of first areas or selecting an image displayed in the area, the control unit switches from the first display mode to the second display mode.

(33) A display program enables a computer to execute a display step in which a plurality of images are displayed at a display screen and a control step in which control is executed so as to select a first display mode or a second display mode for a display mode in which the plurality of images are displayed at the display screen. The first display mode is a display mode which includes a plurality of first areas and a plurality of first images, and the second display mode is a display mode which includes a plurality of second areas and a plurality of second images. At least one of the plurality of second areas has a size different from the sizes of the plurality of first areas or the number of the plurality of second areas is different from the number of the plurality of first areas, and the content of at least one image among the plurality of second images is different from the content of the plurality of first images. In the control step, once at least one of an instruction for image selection issued to select at least one image among the plurality of first images and an instruction for area selection issued to select at least one area among the plurality of first areas is detected, the display mode is switched from the first display mode to the second display mode.

(34) A display method comprises a display step in which a plurality of images are displayed at a display screen and a control step in which control is executed so as to select a first display mode or a second display mode for a display mode in which the plurality of images are displayed at the display screen. The first display mode is a display mode which includes a plurality of first areas and a plurality of first images, and the second display mode is a display mode which includes a plurality of second areas and a plurality of second images. In the control step, once at least one of an instruction for image selection issued to select at least one image among the plurality of first images and an instruction for area selection issued to select at least one area among the plurality of first areas is detected, the display mode is switched from the first display mode to the second display mode.

The disclosures of the following priority applications are herein incorporated by reference.

Japanese Patent Application No. 2015-234193, filed Nov. 30, 2015

Japanese Patent Application No. 2015-234194, filed Nov. 30, 2015.

### REFERENCE SIGNS LIST

1 . . . image reproduction system, 2 . . . network, 3 . . . server, 4 . . . information terminal, 5, 5a, 5b . . . camera, 6a, 6b . . . wireless relay station, 7 . . . portable device, 30 . . . storage device, 70 . . . control unit

1-34. (canceled)

35. A display device, comprising:
a display at which an image is displayed; and
a controller that controls the display so as to display according to a first display mode in which images are displayed at areas divided in a first pattern or according to a second display mode in which images are displayed at areas divided in a second pattern different from the first pattern, the second display mode being different from the first display mode, wherein:
in the first display mode, at least a first image and a second image are displayed in the areas divided in the first pattern;
in the second display mode, at least the first image and a third image that is not displayed in the first display mode are displayed in the areas divided in the second pattern; and
the controller is configured to detect an operation or instruction to the display, and upon detecting the operation or instruction, the controller switches between the first display mode and the second display mode.

36. The display device according to claim 35, wherein:
an area in the first pattern at which the first image is displayed in the first display mode has a size or a shape different from a size or a shape of an area in the second pattern at which the first image is displayed in the second display mode.

37. The display device according to claim 35, wherein:
the number of the areas divided in the first pattern is different from the number of the areas divided in the second pattern, and at least one of the areas divided in the first pattern has a size or a shape different from a size or a shape of the areas divided in the second pattern.

38. The display device according to claim 35, wherein:
the third image is an image related to the first image.

39. The display device according to claim 35, wherein:
in the second display mode, the second image is displayed at an area in the second pattern.

40. The display device according to claim 35, wherein:
in the second display mode, the second image is not displayed at the areas in the second pattern.

41. The display device according to claim 35, wherein:
the operation or instruction to the display is an operation or instruction for selecting an image to be displayed at the areas divided in the first pattern or for selecting an image to be displayed at the areas divided in the second pattern.

42. The display device according to claim 35, wherein:
the operation or instruction to the display is an operation or instruction for selecting an area in the first pattern or for selecting an area in the second pattern.

43. The display device according to claim 35, wherein:
the controller controls the number of images displayed at the display so as not to exceed a fixed value.

44. The display device according to claim 35, wherein:
upon detecting the operation or instruction to the display after the number of images displayed at the display reaches a fixed value, the controller replaces an oldest image displayed at the display with an image which has not yet been displayed.

45. The display device according to claim 35, wherein:
the controller displays the third image by setting an areal size of the third image equal to or greater than a predetermined size.

46. The display device according to claim 35, wherein:
the controller continuously adjusts correspondence between the third image and the areas in the second display mode based upon a length of time over which the operation or instruction to the display is detected.

47. The display device according to claim 35, wherein:
the controller continuously adjusts correspondence between the third image and the areas in the second display mode based upon a strength of a pressing force via which the operation or instruction to the display is detected.

48. The display device according to claim 35, wherein:
at least one area in the second display mode is carried over from an area displayed in the first display mode.

49. The display device according to claim 35, wherein:
if a size of at least one area in the second display mode is different from sizes of the areas in the first display mode, at least one factor among the number of the areas, shapes of the areas and positions of the areas is also different; and
if the number of the areas in the second display mode is different from the number of the areas in the first display mode, at least one factor among the shapes of the areas, the positions of the areas and the sizes of the areas is also different.

50. The display device according to claim 35, wherein:
if the operation or instruction is a lock instruction for locking at least one display mode included in the first display mode as part thereof, the controller controls the display in the second display mode without altering the display mode indicated in the lock instruction.

51. The display device according to claim 35, wherein:
the controller detects, as the operation or instruction, at least one of an operation at an operation member and a gesture detected via a predetermined detector.

52. The display device according to claim 35, wherein:
the controller adjusts both the display mode and the images based upon a history indicating at least one of a length of time over which each image was viewed previously and the number of times each image was viewed previously, in addition to the operation or instruction.

53. The display device according to claim 35, wherein:
the images include video clips; and
the controller designates the video clips to at least one area among the areas in the display and plays back the video clips in the one area through time-division.

54. The display device according to claim 35, wherein:
if there is an image related to an image displayed at at least one area among the areas in the display, the controller controls the display to display an index indicating presence of the related image.

55. The display device according to claim 54, wherein:
in response to a predetermined operation performed while the index is displayed at the display, the controller switches from the one area to a new area and the display displays the related image in the new area.

56. The display device according to claim 35, wherein:
the controller switches the display mode at the display from the first display mode to the second display mode based upon viewer information pertaining to a viewer that views the display; and
the viewer information is personal information that varies from one individual to another.

57. The display device according to claim 56, wherein:
the viewer information is information related to an environment surrounding the viewer.

58. The display device according to claim 56, wherein:
the personal information is information pertaining to a schedule set for the viewer for at least a day of viewing.

59. The display device according to claim 58, wherein:
if the schedule is tight to an extent equal to or greater than a predetermined degree, the controller increases the number of the areas compared to the number of the areas displayed with the schedule not as tight as the predetermined degree.

60. The display device according to claim 56, wherein:
the personal information is information indicating preferences of the viewer pertaining to the display mode.

61. The display device according to claim 56, wherein:
the personal information is information pertaining to visual acuity of the viewer.

62. The display device according to claim 61, wherein:
if the visual acuity is equal to or higher than a predetermined level, the display increases the number of the areas compared to the number of the areas displayed if the visual acuity is not as high as the predetermined level.

63. The display device according to claim 62, further comprising:
a detection unit that detects information pertaining to the visual acuity based upon results obtained by capturing an image of at least part of the viewer's face.

64. The display device according to claim 56, wherein:
the controller alters the display mode based upon at least one of a size of a display screen at the display and a resolution achieved at the display, in addition to the viewer information.

65. The display device according to claim 56, wherein:
the images include a related image related to the viewer and an unrelated image that is not related to the viewer; and
the controller sets an area where an image is displayed based upon the related image related to the viewer who is viewing.

66. The display device according to claim 65, wherein:
if the viewer views images, the controller displays the related image, among the images, in the area at the display, whereas if another viewer views images, the controller switches to the unrelated image, among the images, to be displayed in the area at the display.

67. A computer program product containing a display program that enables a computer to execute:
a display step in which images are displayed at a display screen; and
a control step in which control is executed so as to display at the display screen according to a first display mode in which images are displayed at areas divided in a first pattern or according to a second display mode in which images are displayed at areas divided in a second pattern different from the first pattern, the second display mode being different from the first display mode, wherein:
in the first display mode, at least a first image and a second image are displayed in the areas divided in the first pattern;
in the second display mode, at least the first image and a third image that is not displayed in the first display mode are displayed in the areas divided in the second pattern; and
in the control step, upon detecting an operation or instruction to the display screen, a display mode is switched between the first display mode and the second display mode.

68. A display method, comprising:
a display step in which images are displayed at a display screen; and
a control step in which control is executed so as to display at the display screen according to a first display mode in which images are displayed at areas divided in a first pattern or according to a second display mode in which images are displayed at areas divided in a second pattern different from the first pattern, the second display mode being different from the first display mode, wherein:
in the first display mode, at least a first image and a second image are displayed in the areas divided in the first pattern;
in the second display mode, at least the first image and a third image that is not displayed in the first display mode are displayed in the areas divided in the second pattern; and
in the control step, upon detecting an operation or instruction to the display screen, a display mode is switched between the first display mode and the second display mode.
